(19) United States
(12) Patent Application Publication
(10) Pub. No.: US 2024/0243823 A1
(43) Pub. Date: Jul. 18, 2024

(54) FULL DUPLEX UE SELF-INTERFERENCE MEASUREMENT WITH DIFFERENT DL AND UL SUB-CARRIER SPACINGS

(71) Applicant: QUALCOMM Incorporated, San Diego, CA (US)

(72) Inventors: Qian Zhang, Basking Ridge, NJ (US); Yan Zhou, San Diego, CA (US)

(21) Appl. No.: 18/154,542

(22) Filed: Jan. 13, 2023

(51) Int. Cl. H04B 17/345; H04W 24/08

(52) U.S. Cl. CPC H04B 17/345; H04W 24/08

(57) ABSTRACT

The present disclosure relates generally to wireless communications, and more particularly, to techniques for self-interference measurement (SIM) at a user equipment (UE). An apparatus for wireless communications may determine downlink (DL) symbols for measuring a self-interference (SI) between an active uplink (UL) transmit (Tx) beam of the UE and an active downlink (DL) receive (Rx) beam of the UE. The active uplink (UL) transmit (Tx) beam may be based on an uplink (UL) subcarrier spacing (SCS), and the active downlink (DL) receive (Rx) beam may be based on a downlink (DL) subcarrier spacing (SCS). The apparatus may perform a self-interference measurement (SIM) between the active uplink (UL) transmit (Tx) beam and the active downlink (DL) receive (Rx) beam. The apparatus may output for transmission, to a network entity, a report of the at least one self-interference measurement (SIM).

### INTRODUCTION

The present disclosure relates generally to wireless communications, and more particularly, to methods and apparatuses for self-interference measurement (SIM).

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, an apparatus for wireless communications at a user equipment (UE) in a wireless communications system comprises a memory and a processor coupled to the memory and configured to: determine one or more downlink (DL) symbols for measuring a self-interference (SI) between at least one active uplink (UL) transmit (Tx) beam of the UE and at least one active downlink (DL) receive (Rx) beam of the UE, wherein the at least one active uplink (UL) transmit (Tx) beam is based at least in part on an uplink (UL) subcarrier spacing (SCS), and the at least one active downlink (DL) receive (Rx) beam is based at least in part on a downlink (DL) subcarrier spacing (SCS); perform, based at least in part on the one or more downlink (DL) symbols, at least one self-interference measurement (SIM) between the at least one active uplink (UL) transmit (Tx) beam and the at least one active downlink (DL) receive (Rx) beam; and output for transmission, to a network entity, a report of the at least one self-interference measurement (SIM).

In a related aspect, an apparatus for wireless communications at a network entity in a wireless communications system, comprises: a memory; and a processor coupled to the memory and configured to obtain a report of a self-interference measurement (SIM), performed by a UE, between at least one active uplink (UL) transmit (Tx) beam of the UE and at least one active downlink (DL) receive (Rx) beam of the UE, wherein the at least one active uplink (UL) transmit (Tx) beam is based at least in part on an uplink (UL) subcarrier spacing (SCS), and the at least one active downlink (DL) receive (Rx) beam is based at least in part on a downlink (DL) subcarrier spacing (SCS).

In a further aspect, a method for wireless communications at an apparatus for wireless communications at a user equipment (UE) in a wireless communications system comprises: determining one or more downlink (DL) symbols for measuring a self-interference (SI) between at least one active uplink (UL) transmit (Tx) beam of the UE and at least one active downlink (DL) receive (Rx) beam of the UE, wherein the at least one active uplink (UL) transmit (Tx) beam is based at least in part on an uplink (UL) subcarrier spacing (SCS), and the at least one active downlink (DL) receive (Rx) beam is based at least in part on a downlink (DL) subcarrier spacing (SCS); performing, based at least in part on the one or more downlink (DL) symbols, at least one self-interference measurement (SIM) between the at least one active uplink (UL) transmit (Tx) beam and the at least one active downlink (DL) receive (Rx) beam; and outputting for transmission, to a network entity, a report of the at least one self-interference measurement (SIM).

In a related aspect, a method for wireless communications at a network entity in a wireless communications system, comprises: obtaining a report of a self-interference measurement (SIM), performed by a UE, between at least one active uplink (UL) transmit (Tx) beam of the UE and at least one active downlink (DL) receive (Rx) beam of the UE, wherein the at least one active uplink (UL) transmit (Tx) beam is based at least in part on an uplink (UL) subcarrier spacing (SCS), and the at least one active downlink (DL) receive (Rx) beam is based at least in part on a downlink (DL) subcarrier spacing (SCS).

In an aspect, an apparatus for wireless communications at a user equipment (UE) in a wireless communications system comprises: means for determining one or more downlink (DL) symbols for measuring a self-interference (SI) between at least one active uplink (UL) transmit (Tx) beam of the UE and at least one active downlink (DL) receive (Rx) beam of the UE, wherein the at least one active uplink (UL) transmit (Tx) beam is based at least in part on an uplink (UL) subcarrier spacing (SCS), and the at least one active downlink (DL) receive (Rx) beam is based at least in part on a downlink (DL) subcarrier spacing (SCS); means for performing, based at least in part on the one or more downlink (DL) symbols, at least one self-interference measurement (SIM) between the at least one active uplink (UL) transmit (Tx) beam and the at least one active downlink (DL) receive (Rx) beam; and means for outputting for transmission, to a network entity, a report of the at least one self-interference measurement (SIM).

In a related aspect, an apparatus for wireless communications at a network entity in a wireless communications system, comprises: means for obtaining a report of a self-interference measurement (SIM), performed by a UE, between at least one active uplink (UL) transmit (Tx) beam of the UE and at least one active downlink (DL) receive (Rx) beam of the UE, wherein the at least one active uplink (UL) transmit (Tx) beam is based at least in part on an uplink (UL) subcarrier spacing (SCS), and the at least one active downlink (DL) receive (Rx) beam is based at least in part on a downlink (DL) subcarrier spacing (SCS).

According to a related aspect, a computer program comprises instructions, which when the instructions are executed on a processor of an apparatus for wireless communications at a user equipment (UE) in a wireless communications system, cause said processor to: determine one or more downlink (DL) symbols for measuring a self-interference (SI) between at least one active uplink (UL) transmit (Tx) beam of the UE and at least one active downlink (DL) receive (Rx) beam of the UE, wherein the at least one active (UL) transmit (Tx) beam is based at least in part on an uplink (UL) subcarrier spacing (SCS), and the at least one active downlink (DL) receive (Rx) beam is based at least in part on a downlink (DL) subcarrier spacing (SCS); perform, based at least in part on the one or more downlink (DL) symbols, at least one self-interference measurement (SIM) between the at least one active uplink (UL) transmit (Tx) beam and the at least one active downlink (DL) receive (Rx) beam; and output for transmission, to a network entity, a report of the at least one self-interference measurement (SIM).

In a related aspect, a computer program comprises instructions, which when the instructions are executed on a processor of an apparatus for wireless communications at a network entity in a wireless communications system, cause said processor to: obtain a report of a self-interference measurement (SIM), performed by a UE, between at least one active uplink (UL) transmit (Tx) beam of the UE and at least one active downlink (DL) receive (Rx) beam of the UE, wherein the at least one active uplink (UL) transmit (Tx) beam is based at least in part on an uplink (UL) subcarrier spacing (SCS), and the at least one active downlink (DL) receive (Rx) beam is based at least in part on a downlink (DL) subcarrier spacing (SCS).

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, according to one or more aspects of the present disclosure.

FIG. 2 shows a diagram illustrating an example disaggregated base station architecture, according to one or more aspects of the present disclosure.

FIG. 3A-3D are diagrams illustrating, respectively, an example of a first frame, an example of downlink (DL) channels within a subframe, an example of a second frame, and an example of uplink (UL) channels, according to one or more aspects of the present disclosure.

FIG. 4 is a diagram illustrating an example of a network entity (e.g., base station) and user equipment (UE) in an access network, according to one or more aspects of the present disclosure.

FIGS. 5A-5B are diagrams illustrating examples of a wireless network operating in a semi-static time-division duplex (TDD) configuration or a dynamic TDD configuration, respectively, according to one or more aspects of the present disclosure.

FIGS. 6A-6C are diagrams illustrating examples of full duplex (FD) communications, according to one or more aspects of the present disclosure.

FIGS. 7A-7D are diagrams illustrating further examples of full duplex (FD) communications, according to one or more aspects of the present disclosure.

FIG. 8 is a diagram illustrating an example of a beam measurement process, according to one or more aspects of the present disclosure.

FIG. 9 is a diagram illustrating an example for a self-interference measurement (SIM) process/procedure at a user equipment (UE), according to one or more aspects of the present disclosure.

FIG. 10 is a diagram illustrating a further example for a self-interference measurement (SIM) process/procedure at a user equipment (UE), according to one or more aspects of the present disclosure.

FIGS. 11A-111B illustrate configurations for self-interference measurement (SIM) processes based on downlink (DL) receive (Rx) timing and uplink (UL) transmit (Tx) timing, according to one or more aspects of the present disclosure.

FIG. 12 is an example of a call flow diagram of signaling between a user equipment (UE) and a network entity (e.g., base station), according to one or more aspects of the present disclosure.

FIG. 13 is an example of a flowchart of a method of wireless communication at a user equipment (UE), according to one or more aspects of the present disclosure.

FIG. 14 is an example of a flowchart of a method of wireless communication at a network entity (e.g., base station), according to one or more aspects of the present disclosure.

FIG. 15 is a diagram illustrating an example of a hardware implementation for an example apparatus at a user equipment (UE), according to one or more aspects of the present disclosure.

FIG. 16 is a diagram illustrating an example of a hardware implementation for an example apparatus at a network entity (e.g., base station), according to one or more aspects of the present disclosure.

FIG. 17 is a diagram illustrating another example of a hardware implementation for a user equipment (UE) apparatus or part thereof, according to one or more aspects of the present disclosure.

FIG. 18 is a diagram illustrating another example of a hardware implementation for a network entity (e.g., base station) apparatus or part thereof, according to one or more aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

According to one or more aspects of the present disclosure, the benefits of full duplex (FD) are discussed, and more specifically, simultaneous downlink (DL) and uplink (UL) transmission and different associated aspects. Full duplex (FD) capability may be present either at a network entity (e.g., a base station (which may have a distributed architecture), a transmission-reception point (TRP), a giga Node B (gNB), etc.) or at a user equipment (UE), or both. For example, at the UE, the UL transmission may be from one (antenna) panel and the downlink (DL) reception may be at another (antenna) panel. Similarly, in one example, at the network entity, the reception in uplink (UL) may be at one (antenna) panel and the transmission in downlink (DL) may be from another panel. In some aspects, the full duplex (FD) capability may be conditional on beam separation and other factors. In one of more aspects, the full duplex (FD) capability may be limited by self-interference.

The self-interference (SI) may be caused by radio frequency (RF) leakage between the UL Tx beam and the DL RX beam of the UE, in which case it is referred to as “leaked” self-interference. Additionally, or alternatively, the self-interference (SI) may be caused by reflections/echo from one or more nearby reflectors of the signal transmitted via the UL Tx beam by the UE, which is received indirectly as clutter echo at the DL Rx beam, in which case it is referred to as “clutter echoed” self-interference. In this disclosure, we may use only the general term “self-interference” to refer to either one or both types of “leaked” and “clutter echoed” self-interference.

Therefore, according to one or more aspects of the present disclosure, techniques and apparatuses are disclosed for performing self-interference measurement (SIM) at the UE. This may enable, for example, selection of a best UL/DL beam pair to be used by the UE for full duplex (FD) communication. In some aspects, the selection of the best DL/UL beam pair may be made at the UE. In related aspects, the selection may be made at the network entity communicating with the UE, based at least in part, e.g., on one or more self-interference measurement (SIM) results provided by the UE.

Some of the benefits of the disclosed techniques and apparatuses may comprise latency reduction, for example, receiving downlink (DL) signals in uplink (UL) only slots. Other benefits may comprise spectrum efficiency enhancements (e.g., per cell and/or per UE), more efficient resource utilization, and coverage enhancements.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network (NW), a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

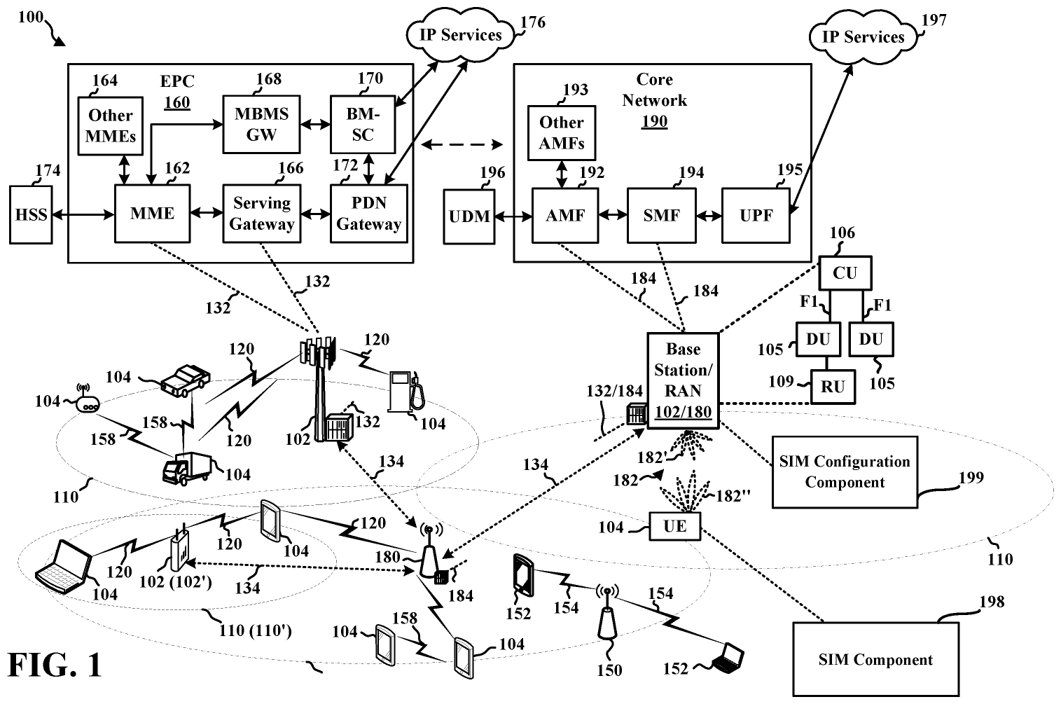

FIG. 1 is a diagram illustrating an example of a wireless communications system and an access network 100. The wireless communications system (also referred to as a wireless wide area network (WWAN)) includes base stations 102, UEs 104, an Evolved Packet Core (e.g., an EPC 160), and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station (e.g., one of the base stations 102 or one of base stations 180) may be referred to as a RAN and may include aggregated or disaggregated components. As an example of a disaggregated RAN, a base station may include a central unit (CU) (e.g. a CU 106), one or more distributed units (DU) (e.g., a DU 105), and/or one or more remote units (RU) (e.g., an RU 109), as illustrated in FIG. 1. A RAN may be disaggregated with a split between the RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs may be connected via an F1 interface. A DU 105 and an RU 109 may be connected via a fronthaul interface. A connection between the CU 106 and a DU 105 may be referred to as a midhaul, and a connection between a DU 105 and the RU 109 may be referred to as a fronthaul. The connection between the CU 106 and the core network 190 may be referred to as the backhaul.

The RAN may be based on a functional split between various components of the RAN, e.g., between the CU 106, the DU 105, or the RU 109. The CU 106 may be configured to perform one or more aspects of a wireless communication protocol, e.g., handling one or more layers of a protocol stack, and the one or more DUs may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. The CU 106 may host higher layer functions, e.g., above the RLC layer, such as a service data adaptation protocol (SDAP) layer, a packet data convergence protocol (PDCP) layer, and/or an upper layer. In other implementations, the split between the layer functions provided by the CU, the DU, or the RU may be different.

The base stations 102 may wirelessly communicate with the UEs 104. Each of the base stations 102 may provide communication coverage for a respective geographic coverage area 110. There may be overlapping geographic coverage areas. For example, the small cell 102′ may have a coverage area 110′ that overlaps the respective geographic coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication links, such as a D2D communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP), such as an AP 150, in communication with Wi-Fi stations (STAs), such as STAs 152, via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as a gNB, may operate in a traditional sub 6 GHz spectrum, in millimeter wave frequencies, and/or near millimeter wave frequencies in communication with the UE 104. When the gNB operates in millimeter wave or near millimeter wave frequencies, the base station 180 may be referred to as a millimeter wave base station. A millimeter wave base station may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (e.g., an MME 162), other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway (e.g., a PDN Gateway 172). The MME 162 may be in communication with a Home Subscriber Server (HSS) (e.g., an HSS 174). The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) (e.g., an AMF 192), other AMFs 193, a Session Management Function (SMF) 194, and a User Plane Function (UPF) (e.g., a UPF 195). The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. In some aspects, the base station or gNB may be referred to as “network entity”. The “network entity” may have a distributed architecture, comprising a central unit (CU) and one or more distributed units (DUs). For example, a gNB may comprise a gNB-CU and a plurality of gNB-DUs. The gNB-DUs may be referred to as “network nodes” or TRPs. The base station 102 provides an access point to the EPC 160 or core network 190 for a UE 104.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network. In some aspects, the term “UE” may be used throughout the present disclosure to denote an entity in an Open Radio Access Network (O-RAN) architecture.

Referring to FIG. 1, in certain aspects, the UE 104 may be configured to perform a self-interference measurement (SIM) procedure. For example, the UE 104 of FIG. 1 may include a self-interference measurement (SIM) component 198 configured to measure for at least one pair of UL Tx/DL Rx beams of a subset of UL Tx/DL Rx beams of the UE a self-interference (SI), e.g., based on sounding reference signals (SRSs) transmitted from the UL Tx beam of the UE and received at the DL Rx beam of the UE.

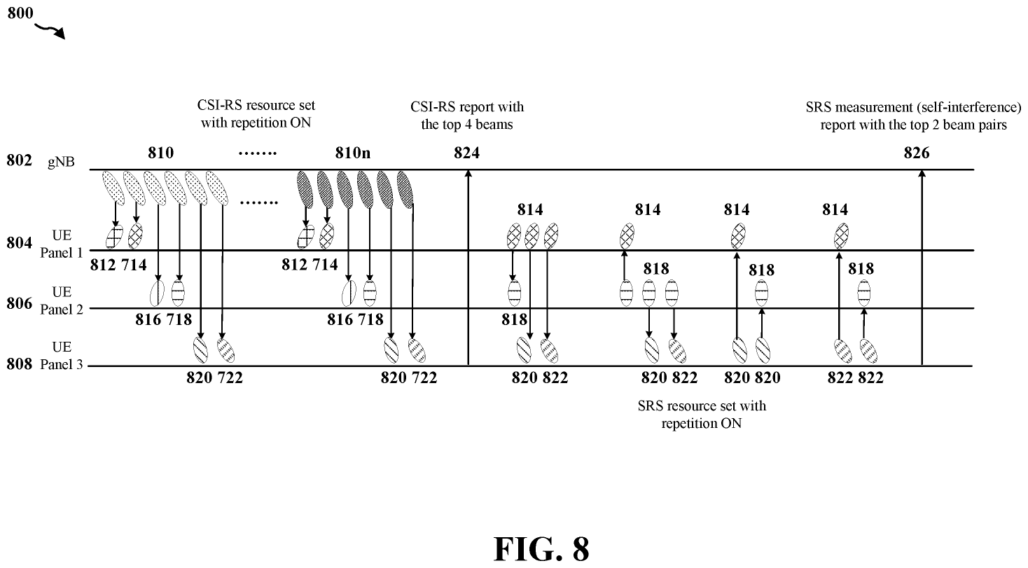

First, the UE 104 may determine a subset of DL Rx beams based on a beam measurement process. Additionally, or alternatively, a network entity (e.g., base station) 102/180 may configure the UE 104 with a subset of DL Rx beams. Each DL Rx beam of the subset of DL Rx beams may be associated with one antenna array panel of a plurality of different antenna array panels. In order to perform the SIM process (which may be referred to, interchangeably, as SIM procedure in the present disclosure), the UE 104 may sweep through transmitting a SRS from a same UL Tx beam (e.g., the UL Tx beam may be fixed) corresponding to each DL Rx beam of one panel of the plurality of different panels and receive the transmitted SRS incrementally through other DL Rx beams associated with other panels of the plurality of different panels (see example of FIG. 8). The UE 104 may measure for at least one pair of UL Tx/DL Rx beams of the subset of beams a self-interference (SI) value based on the received SRS. The UE 104 may select one or more pairs of UL Tx/DL Rx beams based at least on the self-interference measurement (SIM) process. In some aspects, the selection may also consider cross link interference (CLI) as well, wherein the UE 104 may receive an indication on high CLI beams from the network entity (e.g., base station) 120/180. The UE 104 may report the selected one or more pairs of UL Tx/DL Rx beams to the network entity (e.g., base station) 120/180. Additionally, or alternatively, the UE 104 may transmit the SIM report comprising the SI values to the network entity (e.g., base station) 120/180 and receive a configuration comprising the best UL Tx/DL Rx beam pair or one or more of the best pairs of UL Tx/DL Rx beams of the UE. For example, the “best” may refer to a selection based on the SIM values satisfying a threshold (e.g., less than the threshold, which may be predetermined or configurable). However, in some cases, no UL Tx/DL Rx beam pair may satisfy the threshold.

Referring again to FIG. 1, in certain aspects, the network entity (e.g., base station) 102/180 may be operable to configure a UE 104 for performing the self-interference measurement (SIM) procedure. For example, the network entity (e.g., base station) 102/180 of FIG. 1 may include a self-interference measurement (SIM) configuration component 199 operable to configure the UE 104 for performing a self-interference measurement (SIM) procedure and/or for selecting a UL Tx beam/DL Rx beam pair with the first UE 104. The base station 102/180 may configure the UE 104 for a SIM process. The base station 102/180 may receive, from the UE 104, a SIM report indicating SIM results from the SIM process. Additionally, or alternatively, the network entity (e.g., base station) 102/180 may configure the UE 104 for a CLI process with a set of neighbor UEs. The network entity (e.g., base station) 102/180 may receive, from each UE of the set of neighbor UEs, a CLI measurement report. The network entity (e.g., base station) 102/180 may select a UL Tx beam/DL Rx beam pair for communicating with the UE 104 based on at least one of the received SIM report or the CLI report from the set of neighbor UEs.

The self-interference (SI) may be caused by radio frequency (RF) leakage between the UL Tx beam and the DL RX beam of the UE, in which case it is referred to as “leaked” self-interference. Additionally, or alternatively, the self-interference (SI) may be caused by reflections/echo from one or more nearby reflectors of the signal transmitted via the UL Tx beam by the UE, which is received indirectly as clutter echo at the DL Rx beam, in which case it is referred to as “clutter echoed” self-interference. In this disclosure, we may use only the general term “self-interference” to refer to either one or both types of “leaked” and “clutter echoed” self-interference.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

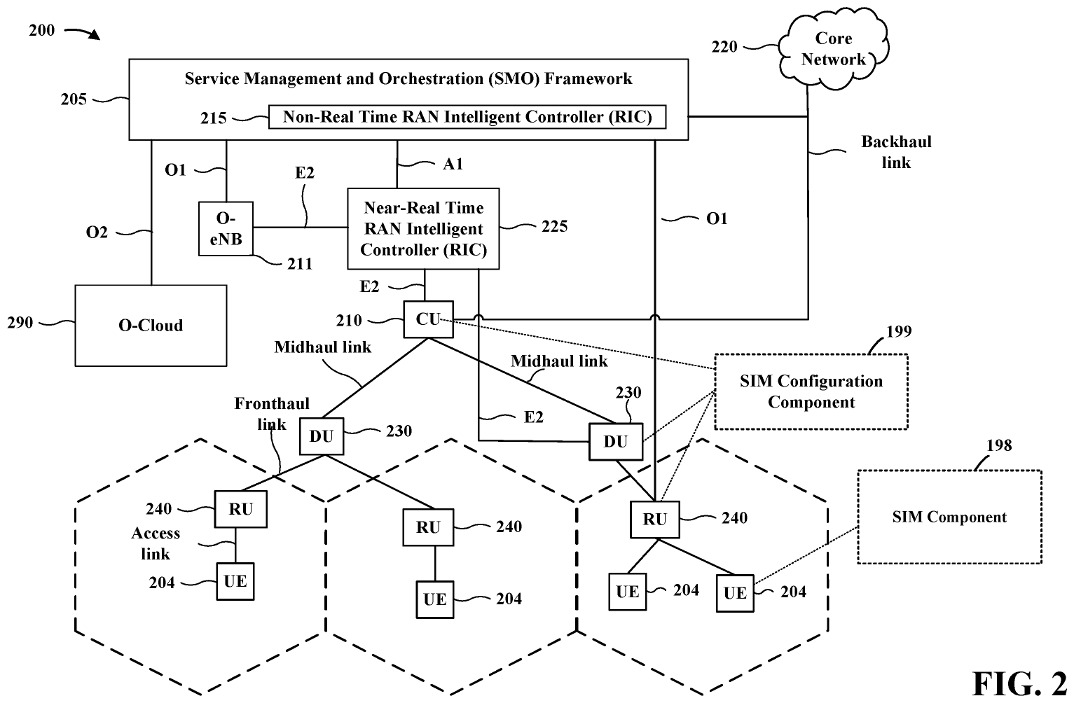

FIG. 2 shows a diagram illustrating an example disaggregated base station 200 architecture. The disaggregated base station 200 architecture may include one or more CUs 210 that can communicate directly with a core network 220 via a backhaul link, or indirectly with the core network 220 through one or more disaggregated base station units (such as a Near-Real Time (Near-RT) RAN Intelligent Controller (RIC) (e.g., a Near-RT RIC 225) via an E2 link, or a Non-Real Time (Non-RT) RIC (e.g., a Non-RT RIC 215) associated with a Service Management and Orchestration (SMO) Framework (e.g., an SMO Framework 205), or both). A CU of the one or more CUs 210 may communicate with one or more DUs 230 via respective midhaul links, such as an F1 interface. The one or more DUs 230 may communicate with one or more RUs 240 via respective fronthaul links. The one or more RUs 240 may communicate with respective UEs via one or more radio frequency (RF) access links. In some implementations, a UE may be simultaneously served by multiple RUs.

Each of the units, i.e., the one or more CUs 210, the one or more DUs 230, the one or more RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the one or more CUs 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the one or more CUs 210. The CU may be configured to handle user plane functionality (i.e., Central Unit-User Plane (CU-UP)), control plane functionality (i.e., Central Unit-Control Plane (CU-CP)), or a combination thereof. In some implementations, the CU can be logically split into one or more CU-UP units and one or more CU-CP units. The CU-UP unit can communicate bidirectionally with the CU-CP unit via an interface, such as the E1 interface when implemented in an O-RAN configuration. The CU can be implemented to communicate with the DU, as necessary, for network control and signaling.

The one or more DUs 230 may correspond to a logical unit that includes one or more base station functions to control the operation of one or more RUs 240. In some aspects, the one or more DUs 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the one or more DUs 230 may further host one or more low PHY layers. Each layer (or module) can be implemented with an interface configured to communicate signals with other layers (and modules) hosted by the one or more DUs 230, or with the control functions hosted by the one or more CUs 210.

Lower-layer functionality can be implemented by one or more RUs 240. In some deployments, an RU, controlled by a DU, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the one or more RUs 240 can be implemented to handle over the air (OTA) communication with one or more UEs 204. In some implementations, real-time and non-real-time aspects of control and user plane communication with the RU(s) can be controlled by the corresponding DU. In some scenarios, this configuration can enable the one or more DUs 230 and the one or more CUs 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, one or more CUs 210, one or more DUs 230, one or more RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

A wireless device, such as the UE 204 in FIG. 2, may include a self-interference measurement (SIM) component 198 configured to measure for at least one pair of Tx/Rx beams of a subset of beams a self-interference (SI) based on sounding reference signals (SRSs) transmitted from the Tx beam and received at the Rx beam (e.g., as explained in connection with the UE 104 of FIG. 1). In certain aspects, the base station 200 (which may correspond to base station 102/180 shown in FIG. 1), or a component thereof, such as CU 210, DU 230, RU 240, may be operable to configure the UE 204 (or, correspondingly, the UE 104 of FIG. 1) for performing a self-interference measurement (SIM) procedure. For example, the base station 200 may include a self-interference measurement (SIM) configuration component 199 operable to configure the UE 204 for performing the SIM procedure and/or for selecting a Tx beam/Rx beam pair with the first UE 204. The base station 200 may configure the UE 204 for the SIM procedure. The base station 200 may receive, from the UE 204, a SIM report indicating SIM results from the SIM procedure/process.

The self-interference (SI) may be caused by radio frequency (RF) leakage between the UL Tx beam and the DL RX beam of the UE, in which case it is referred to as “leaked” self-interference. Additionally, or alternatively, the self-interference (SI) may be caused by reflections/echo from one or more nearby reflectors of the signal transmitted via the UL Tx beam by the UE, which is received indirectly as clutter echo at the DL Rx beam, in which case it is referred to as “clutter echoed” self-interference. In this disclosure, we may use only the general term “self-interference” to refer to either one or both types of “leaked” and “clutter echoed” self-interference.

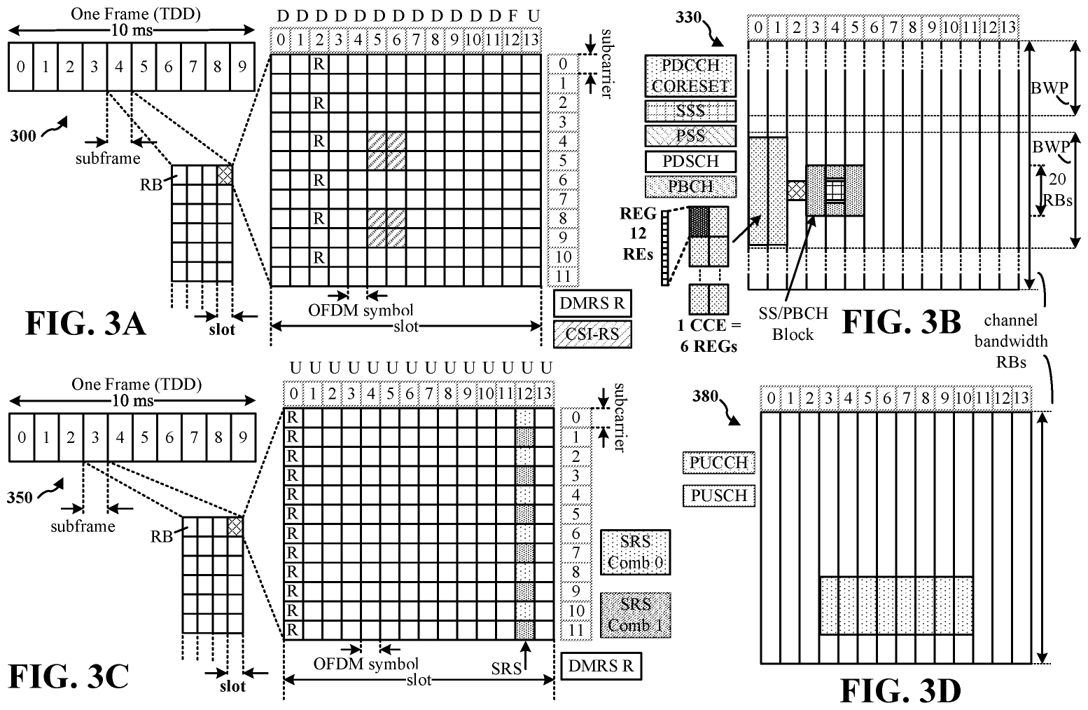

FIG. 3A is a diagram 300 illustrating an example of a first subframe within a 5G NR frame structure. FIG. 3B is a diagram 330 illustrating an example of DL channels within a 5G NR subframe. FIG. 3C is a diagram 350 illustrating an example of a second subframe within a 5G NR frame structure. FIG. 3D is a diagram 380 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 3A-3D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2μ slots/subframe. As shown in Table 1, the subcarrier spacing may be equal to 2^{μ}*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 3B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

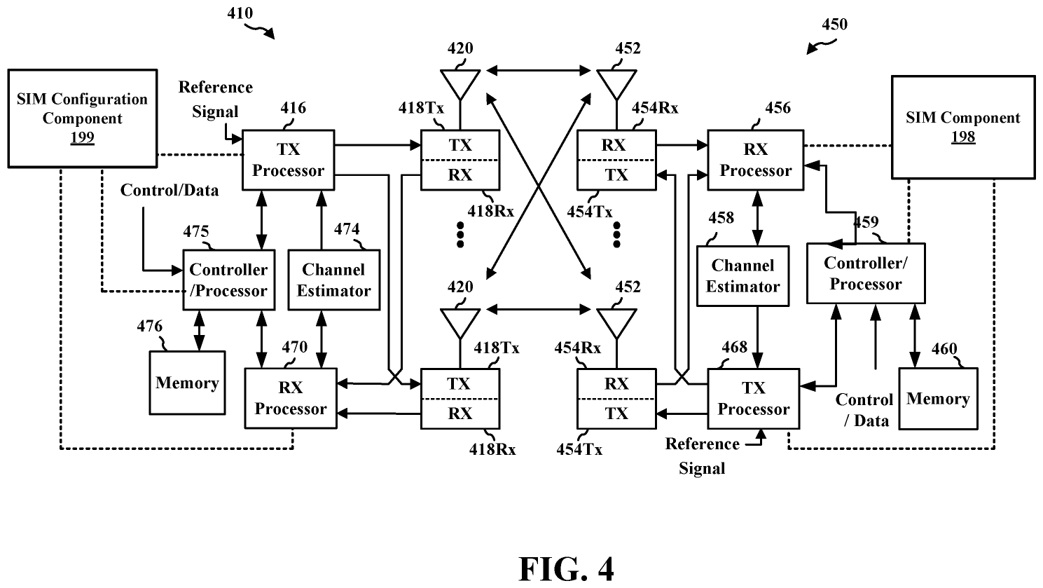

FIG. 4 is a block diagram that illustrates an example of a first wireless device that is configured to exchange wireless communication with a second wireless device. In the illustrated example of FIG. 4, the first wireless device may include a base station 410, the second wireless device may include a UE 450, and the base station 410 may be in communication with the UE 450 in an access network. As shown in FIG. 4, the base station 410 includes a transmit processor (TX processor 416), a transmitter 418Tx, a receiver 418Rx, antennas 420, a receive processor (RX processor 470), a channel estimator 474, a controller/processor 475, and memory 476. The example UE 450 includes antennas 452, a transmitter 454Tx, a receiver 454Rx, an RX processor 456, a channel estimator 458, a controller/processor 459, memory 460, and a TX processor 468. In other examples, the base station 410 and/or the UE 450 may include additional or alternative components.

In the DL, Internet protocol (IP) packets may be provided to the controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 416 and the RX processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna of the antennas 420 via a separate transmitter (e.g., the transmitter 418Tx). Each transmitter 418Tx may modulate a radio frequency (RF) carrier with a respective spatial stream for transmission.

At the UE 450, each receiver 454Rx receives a signal through its respective antenna of the antennas 452. Each receiver 454Rx recovers information modulated onto an RF carrier and provides the information to the RX processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, two or more of the multiple spatial streams may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with the memory 460 that stores program codes and data. The memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer ofupper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna of the antennas 452 via separate transmitters (e.g., the transmitter 454Tx). Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna of the antennas 420. Each receiver 418Rx recovers information modulated onto an RF carrier and provides the information to the RX processor 470.

The controller/processor 475 can be associated with the memory 476 that stores program codes and data. The memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 468, the RX processor 456, and the controller/processor 459 may be configured to perform aspects in connection with the self-interference measurement (SIM) component 198 of FIG. 1 and/or FIG. 2.

At least one of the TX processor 416, the RX processor 470, and the controller/processor 475 may be configured to perform aspects in connection with the self-interference measurement (SIM) configuration component 199 of FIG. 1 and/or FIG. 2.

The self-interference (SI) may be caused by radio frequency (RF) leakage between the UL Tx beam and the DL RX beam of the UE, in which case it is referred to as “leaked” self-interference. Additionally, or alternatively, the self-interference (SI) may be caused by reflections/echo from one or more nearby reflectors of the signal transmitted via the UL Tx beam by the UE, which is received indirectly as clutter echo at the DL Rx beam, in which case it is referred to as “clutter echoed” self-interference. In this disclosure, we may use only the general term “self-interference” to refer to either one or both types of “leaked” and “clutter echoed” self-interference.

### Cross-Link Interference

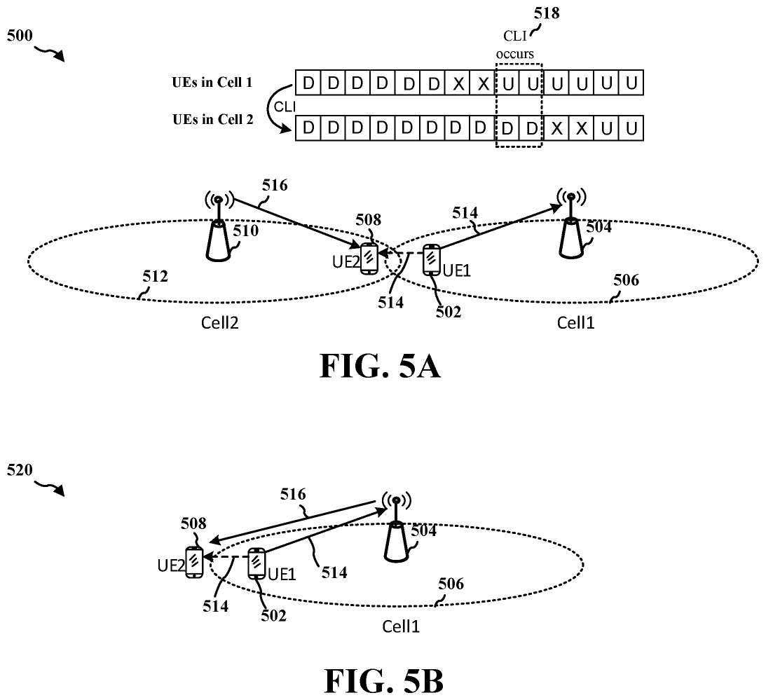

FIG. 5A shows a diagram of a wireless network 500 which may be operating according to a semi-static time-division duplex (TDD) configuration. FIG. 5B shows a diagram of a wireless network 520 which may be operating according to a dynamic time-division duplex (TDD) configuration. In some aspects, dynamic TDD may advantageously enhance the spectrum efficiency of wireless communication networks and provide a higher throughput by dynamically altering uplink (UL) or downlink (DL) transmission direction. The configuration of dynamic TDD may change dynamically in response to a change of traffic pattern. For example, in instances where the traffic pattern is UL heavy, dynamic TDD may recognize the change in the traffic pattern and adapt by providing more UL symbols to meet the demand. Alternatively, in instances where the traffic pattern is DL heavy, dynamic TDD may provide more DL symbols to meet the demand.

In certain instances, if nearby UEs have different TDD UL-DL slot formats, one UE (e.g., UE2 508) may be a victim and may receive UL transmission from another UE (e.g., UE1 502) known as an aggressor. The received UL transmission from the UE1 502 may be denoted as “cross-link interference” (CLI). In some aspects, CLI may occur when a UL symbol (e.g., an interfering symbol) of an aggressor collides with a DL symbol (e.g., an interfered symbol) of a victim. Accordingly, CLI may be caused by an UL transmission from the aggressor UE (e.g., 502).

For example, in FIG. 5A, UE1 502 is within Cell1 506 and is being served by base station 504, while UE2 508 is within Cell2 512 and is being served by base station 510. CLI may occur between UEs at the cell edges of nearby cells, as UEs at cell edges of nearby cells may be in close proximity to each other. As shown in FIG. 5A, UE1 502 and UE2 508 are at their respective cell edges, and may be communicating with their respective base stations. UE1 502 may send an UL transmission 514 to base station 504, while UE2 508 is receiving a DL transmission 516 from base station 510. However, in some cases, the UL transmission 514 sent by UE1 502 to base station 504 may also be received by UE2 508 while receiving the DL transmission 516 from base station 510. The UL transmission 514 from UE1 502 received by UE2 508 causes CLI 514 (which is shown in dotted line) and may interfere with the DL transmission 516 UE2 508 from base station 510. As such, one or more UL symbols of the CLI 514 may collide with one or more DL symbols of the DL transmission 516. In the example of FIG. 5A, two UL symbols of the CLI signal 514 overlap or collide with two DL symbols of the DL transmission 516, such that CLI occurs at the overlap 518.

In the example of FIG. 5B, both UE1 502 and UE2 508 are being served by the same cell (e.g., cell1 506). Both UE 1 502 and UE2 508 are near the cell edge, and in some instances, the UL transmission 514 sent by UE1 502 to base station 504 may also be received by UE2 508 while receiving the DL transmission 516 from base station 504. The UL transmission 514 from UE1 502 received by UE2 may cause CLI 514 (which is shown in dotted line) and may interfere with the DL 516 of UE2 508 from the base station 504. As such, one or more UL symbols of the CLI 514 may collide with one or more DL symbols of the DL transmission 516.

CLI measurements metrics may include sounding reference signals reference signal received power (SRS-RSRP) and CLI-reference signal strength indicator (CLI-RSSI). SRS-RSRP may include the linear average of the power contributions of the SRS to be measured over the configured resource elements within the considered measurement frequency bandwidth in the time resources in the configured measurement occasions. CLI-RSSI may include the linear average of the total received power observed only in certain OFDM symbols of measurement time resource(s), in the measurement bandwidth, over the configured resource elements for measurement by the UE. For both SRS-RSRP and CLI-RSSI measurement reports, both events may be triggered and periodic reporting may be supported. Layer3 (L3) filtering may be applied, such that for CLI-RSSI measurements, the implementation of the UE may determine whether to reset filtering upon a bandwidth part (BWP) switch. A dedicated measurement gap may not be needed. Each component carrier (CC), e.g., 100 MHz, can configure up to 4 DL BWPs and UL BWPs (for TDD, each DL BWP is paired with an UL BWP). How each BWP is configured is up to gNB implementation/configuration.

### Full Duplex Communication and Self-Interference

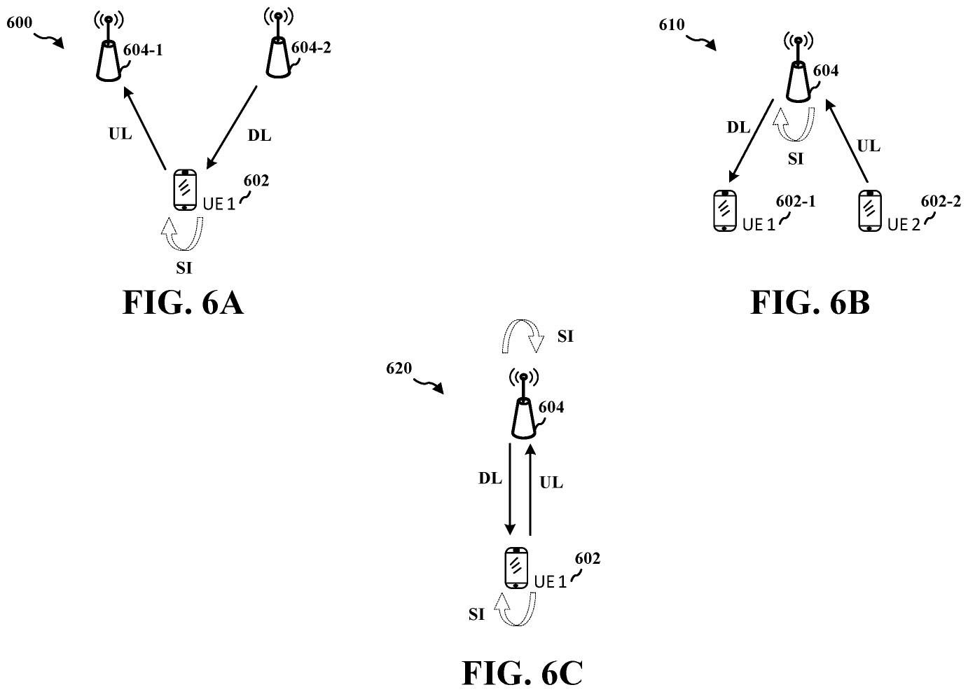

FIGS. 6A-6C are diagrams illustrating examples 600, 610, 620 of full duplex (FD) communication in accordance with one or more aspects of the present disclosure.

The first example 600 of FIG. 6A illustrates a UE1 602 and two base stations (e.g., TRPs) 604-1, 604-2, wherein the UE1 602 is sending UL transmissions to base station 604-1 and is receiving DL transmissions from base station 604-2. The base stations 604-1 and 604-2 may represent gNB-DUs (“network nodes”) associated with the same or different gNB (“network entity”). In the example 600 of FIG. 6A, FD is enabled for the UE1 602, but not for the base stations 604-1, 604-2. The FD communication enabled at the UE1 602 may cause self-interference (SI) at the UE1 602 between the UL and DL transmissions, as shown by the dotted curved arrow.

The example 610 of FIG. 6B includes two UEs, UE1 602-1 and UE2 602-2 and a base station 604, wherein the UE1 602-1 is receiving a DL transmission from the base station 604 and the UE2 602-2 is transmitting a UL transmission to the base station 604. In the example 610 of FIG. 6B, FD is enabled for the base station 604, but not for the UEs UE1 602-1 and UE2 602-2 (although there may be CLI between the UEs). The FD communication may cause self-interference (SI) at the base station 604 between the UL and DL transmissions, as illustrated by the dotted curved arrow.

Finally, the example 620 of FIG. 6C includes a UE1 602 and a base station 604, wherein the UE1 602 is receiving a DL transmission from the base station 604 and the UE1 602 is transmitting a UL transmission to the base station 604. In the example 620 of FIG. 6C, FD is enabled for both the UE1 602 and the base station 604. This may cause self-interference (SI) at both the UE1 602 and the base station 604 between the UL and DL transmissions, which is shown by the dotted curved arrows.

### Example Deployment Scenarios

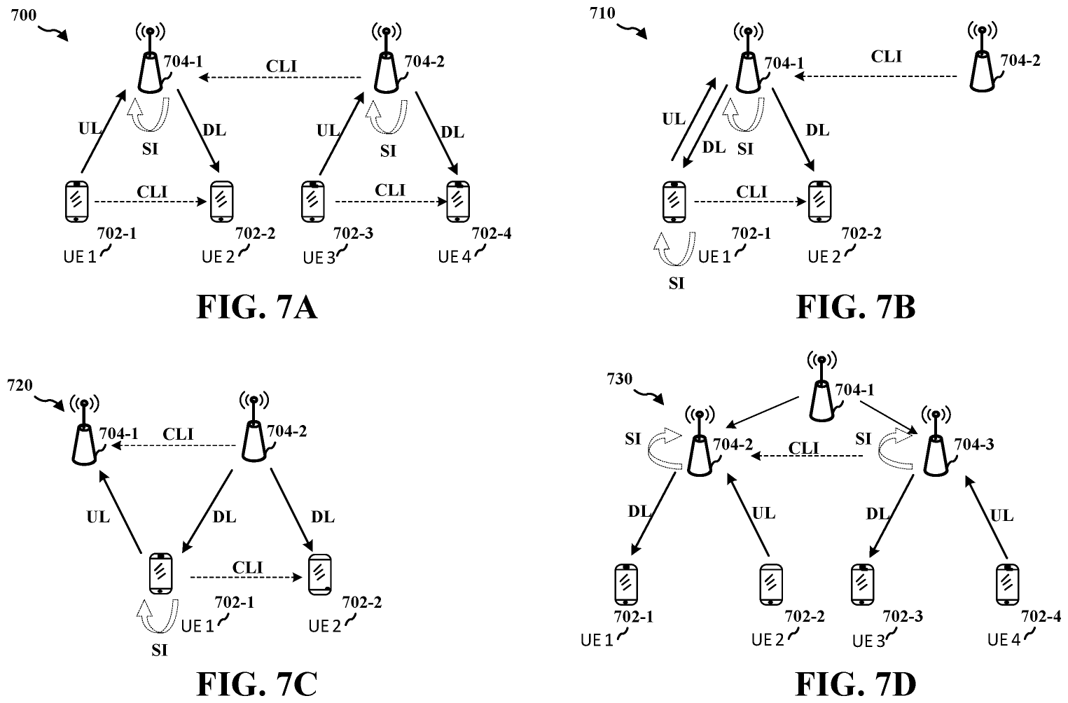

FIGS. 7A-7D illustrate different deployment scenarios of FD communications which may cause both cross-link interference (CLI) and self-interference (SI) at the UEs, the base stations, or both. For example, FIG. 7A illustrates a first deployment scenario 600 involving four UEs, i.e., UE1 702-1, UE2 702-2, UE3 702-3, UE4 702-4, and two base stations 704-1, 704-2. The UE1 702-1 transmits in UL to the base station 704-1 and UE2 702-2 receives in DL from the base station 704-1. The FD configuration at the base station 704-1 with UL reception from the UE1 702-1 and DL transmission to the UE2 702-2 may cause self-interference (SI) at the base station 704-1. Moreover, in some cases, the DL reception at the UE2 702-1 may be affected by cross-link interference (CLI) from the UL transmission of the UE1 702-1. Similarly, there may be SI at the base station 704-2 caused by FD communication at the base station 704-2. In some cases, the UE4 may be affected in the DL reception by CLI caused by the UL transmission of the nearby UE3 702-3. In related aspects, the base station 704-2 may cause CLI at the base station 704-1.

FIG. 7B illustrates a second deployment scenario 710 involving two UEs, i.e., UE1 702-1 and UE2 702-2 and two base stations 704-1 and 704-2. FD is enabled at the UE1 702-1 which communicates in both UL and DL with the base station 704-1. Therefore, the UE1 702-1 may be affected by SI in this scenario. Additionally, the base station 704-1 may be affected by SI caused by FD configuration of its UL/DL communications with the UEs. In some cases, the base station 704-1 may be affected by CLI from the neighboring base station 704-2. Finally, the DL reception at the UE2 702-2 may be affected by CLI from the UL transmission at the nearby UE1 702-1.

FIG. 7C illustrates a third deployment scenario 720 involving two UEs, i.e., UE1 702-1 and UE2 702-2 and two base stations 704-1 and 704-2. As shown by the dotted arrow, the base station 704-1 may be affected by CLI from the transmissions of neighboring base station 704-2. Similarly, the UE2 702-2 may be affected by CLI from the nearby UE1 702-1. In some aspects of the present disclosure, FD is enabled at the UE1 702-1, which may cause SI at the UE1 702-1 between the UL transmission to the base station 704-1 and the DL reception from the base station 704-2.

FIG. 7D illustrates a fourth deployment scenario 730 involving four UEs, i.e., UE1 702-1, UE2 702-2, UE3 702-3, and UE4 702-4, and three base stations 704-1, 704-2, and 704-3. In some examples, the base stations 704-2 and 704-3 may be integrated access and backhaul (IAB) nodes (see, e.g., 3GPP Release 17) and the base station 704-1 may be a parent node. The base stations 704-2 and 704-3 may be affected respectively by SI, shown with the dotted curved arrows. Moreover, the base station 704-2 may be affected by CLI from the transmissions of the neighboring base station 704-3. The four UEs are not affected by SI in this scenario, as they are not configured with FD in DL and UL. However, while not shown, the UEs may be affected by CLI.

### Self-Interference Measurement at the UE

In accordance with one or more aspects, the present disclosure relates to FD communication at a UE comprising simultaneous UL/DL transmission/reception in a same frequency range (e.g., FR2). In some aspects, the UE may operate in either frequency division duplex (FDD) or time-division duplex (TDD) modes. In some aspects, the UL and DL subcarrier spacings (SCSs) may be different. Additionally, or alternatively, UL transmission may be from one antenna panel of the UE and DL reception may be at another antenna panel of the UE. In some aspects, enabling FD communication may be conditional on a beam separation of the UL beam and DL beam at the respective antenna panels. FD communication may improve latency (e.g., reduce latency). Moreover, FD communication may enhance spectrum efficiency per cell, or per UE, and may allow for a more efficient utilization of resources.

Beam separation of the UL and DL beams may assist in limiting or reducing self-interference (SI) that may occur during FD communication. For example, it may be desirable to select UL and DL beams that are on different antenna panels to minimize self-interference. Determining the UL and DL beams that are separated on their respective antenna panels may provide a reliable FD communication by selecting beam pairs that minimize or reduce self-interference. As such, measuring the self-interference at the UE may assist in determining beam pairs of UL and DL beams that may support FD communication. It is desirable to improve the manner in which the self-interference measurement (SIM) is configured and performed, for example, when the subcarrier spacings (SCS) of the UL and DL beams at the UE are different.

The self-interference (SI) may be caused by radio frequency (RF) leakage between the UL Tx beam and the DL RX beam of the UE, in which case it is referred to as “leaked” self-interference. Additionally, or alternatively, the self-interference (SI) may be caused by reflections/echo from one or more nearby reflectors of the signal transmitted via the UL Tx beam by the UE, which is received indirectly as clutter echo at the DL Rx beam, in which case it is referred to as “clutter echoed” self-interference. In this disclosure, we may use only the general term “self-interference” to refer to either one or both types of “leaked” and “clutter echoed” self-interference.

FIG. 8 is a diagram 800 illustrating beam and self-interference measurement example processes. The diagram 800 of FIG. 8 includes a base station 802, and a UE comprising multiple UE panels (e.g., UE panel1 804, UE panel2 806, UE panel3 808). The base station 802 may be configured with CSI-RS resource 810 set with repetition. The base station 802 may transmit the CSI-RS resource 810 to each receive (Rx) beam of the UE panels. For example, the CSI-RS resource 810 may be transmitted to Rx beams 812, 814 of UE panel1 804, to Rx beams 816, 818 of UE panel2 806, and to Rx beams 820, 822 of UE panel3 808. In the aspect of FIG. 8, each UE panel is shown as having two Rx beams, however, the disclosure is not intended to be limited to the aspects disclosed herein. In some aspects, the UE panels may have any number of Rx and/or transmit (Tx) beams. The UE panels may measure the received CSI-RS 810 to determine which of the Rx beams are the best at the UE side, which may be based on the signal strength measured at the UE panels.

The base station 802 may transmit multiple CSI-RS resources to the UE panels in order to measure the Rx beams at the UE side. For example, the base station 802 may have “n” CSI-RS transmissions 810n to the UE panels in order to determine which Rx beams are the strongest at the UE side. The UE may then send a CSI-RS report 824 to the base station 802 indicating the top Tx beams at the base station with each Tx beam associated with a Rx beam at the UE side. In some aspects, the top Rx beams may be based at least in part on the received signal strength. For example, the UE may report the top four Tx beams at the base station with each Tx beam associated with a Rx beam at the UE, e.g., beams 814, 818, 820, 822. However, the UE may report more or less than the top four Tx beams at the base station.

Upon the determination of the top associated four Rx beams, the UE may perform a self-interference measurement (SIM) procedure for the four beams. To perform the SIM, the UE may perform a transmission (or repetitive transmissions) of SRS from the beam 814 from UE panel1 804, such that beams 818, 820, and 822 may measure the amount of energy they receive from the transmission of the beam 814. The transmission from the beam 814 may be an uplink transmission to the base station 802, however, during the uplink transmission from beam 814 to the base station 802, some energy may be received at the other panels. Such energy may be due to side lobes or based on the configuration of the other panels. As such, the beams 818, 820, and 822 may measure the amount of self-interference caused by the transmission from the beam 814. This process may be repeated for all of the top four beams indicated in the CSI-RS report. For example, in a next measurement cycle, beam 818 may send a transmission (or repetitive transmissions) such that beams 814, 820, and 822 may measure the amount of self-interference caused by the transmission from beam 818. This process may be repeated with beams 820 and 822 as respective transmission beams and beams 814 and 818 as the self-interference receiving beams.

Upon the completion of the self-interference measurement procedure, a SIM report 826 may be sent by the UE to the base station 802 indicating the top one or more beam pairs based on the SIM results. Additionally, or alternatively, according to some aspects of the present disclosure, the SIM measurement report may contain one or more measurements results, and the base station 702 may select the top one or more beam pairs based at least in part on the SIM measurement report.

To perform the self-interference measurement (SIM) procedure at the UE, a modified CLI configuration and procedure may be utilized. For example, the UE panels when sending the uplink transmission for the self-interference measurement may transmit a sounding reference signal (SRS). The transmitted SRS may be used to measure CLI from one or more neighbor UEs, but the transmitted SRS may also be utilized to measure SIM concurrently for inter-cell UEs and intra-cell UEs. This may allow for the self-interference procedure and CLI procedure to occur concurrently. Self-interference may be measured by sounding reference signal reference signal received power (SRS-RSRP), while total interference may be measured by received signal strength indicator (RSSI). For example, the UE may transmit the SRS at full power to perform the CLI measurement, while the UE may transmit the SRS at a reduced power to perform the SIM. In some aspects, the SRS transmission power may be configured by the base station within an SRS configuration. Indicating to the SRS transmitter that the SRS transmission is for a genuine CLI measurement allows for the SRS to be transmitted at full power. In some aspects, for the Tx configuration, the base station may provide an indication for a genuine CLI measurement (or other measurement processes) or for a full SRS Tx power or for a reduced SRS Tx power. For example, for the Tx configuration, the base station may configure the full Tx power or the reduced Tx power based on X dBm or X % of the full Tx power.

In some aspects, for each measured SRS resource, a Rx QCL information may be added in the SRS resource configuration, which is for Tx. The Rx QCL may be configured in the measurement configuration for SRS-RSRP, for example, similar to the CSI resource setting which is the Rx configuration for the CSI-RS measurement. In the Rx configuration, the base station may also indicate a full or reduced Tx power based on X dBm or X % of full Tx power. In such instances, the Rx UE may scale up the calculated RSRP accordingly. Each SRS resource may be configured to repeat. For example, each SRS resource may be configured to repeat at most N−1 times (e.g., with N candidate beams of 3 panels). Each SRS resource may be configured to repeat having the same or different repetition factor such that its cross-beam RSRP may be measured by the other N−1 UE beams on different panels. Additionally, or alternatively, in some aspects, the inter-UE CLI may be measured by different Rx beams at another neighbor UE or by different neighbor UEs based on the CLI procedure. In some related aspects, for each SRS resource with repetition, the UE implementation may select one applicable Rx beam to measure within a set of candidate Rx beams for SIM, while in some aspects, the measurement of the Rx beam may be guided by the base station based on the SIM configuration. The selection of the DL and UL beam pair may consider SIM and/or CLI measurements (e.g., SIM measurements only, CLI measurements only, or both the SIM and CLI measurements). The beam pair selected is one that has passed a threshold for selection (e.g., the SIM measurements are less than a threshold). However, in some cases, the UE may report to the base station that no beams pass the threshold, such that no feasible beam and/or beam pair is present.

In some related aspects, the base station may be configured to filter out high cross link interference candidate Tx beams for the UE, based on the one or more neighbor UE SRS-RSRP or CLI-RSSI measurement report. The base station may indicate the candidate Tx beams that do not have high interference to the UE. Based on the information sent by the base station, the UE may then be configured to filter out the candidate Tx beams with high CLI, and report the top one or more UL Tx and DL Rx beam pairs having the lowest cross-beam RSRP and/or CLI SRS-RSRP to the base station. The top one or more UL Tx and DL Rx beam pairs may be reported to the base station based on the corresponding CSI-RS IDs. In some aspects, the base station may not send an indication to the UE of the candidate Rx beams having high interference. In such instances, the base station receives the CLI and/or SIM reports from the UE and one or more neighbor UEs, and may consider the CLI and/or SIM reports to select the top one or more UL and DL beam pairs. In some aspects, the UE may report beams with a panel ID in synchronization signal block (SSB)/CSI-RS measurements, such that the base station could avoid configuring intra-panel SIM in an effort to reduce resource overhead.

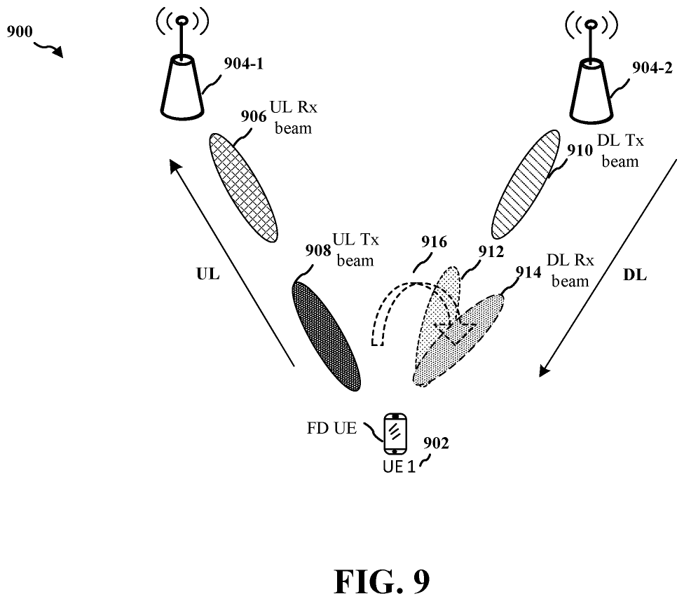

FIG. 9 shows a diagram 900 illustrating an aspect of a baseline option for performing self-interference measurement (SIM) at a user equipment UE1 902 via uplink (UL) traffic (e.g., UE autonomous SIM and reporting may be used as the baseline in order to save overhead). This may comprise using ongoing SRS/DM-RS/PUCCH/PUSCH to do SIM cross-panels (e.g., in half-duplex resources).

The self-interference (SI) may be caused by radio frequency (RF) leakage between the UL Tx beam and the DL RX beam of the UE, in which case it is referred to as “leaked” self-interference. Additionally, or alternatively, the self-interference (SI) may be caused by reflections/echo from one or more nearby reflectors of the signal transmitted via the UL Tx beam by the UE, which is received indirectly as clutter echo at the DL Rx beam, in which case it is referred to as “clutter echoed” self-interference. In this disclosure, we may use only the general term “self-interference” to refer to either one or both types of “leaked” and “clutter echoed” self-interference.

The UE1 may be configured to perform full duplex (FD) communications in the uplink with a first network node 904-1 and in the downlink with a second network node 904-2. In some aspects, the first network node 904-1 and the second network node 904-2 may be transmission reception points (TRPs) (e.g., gNB-DUs) associated with the same network entity (e.g., gNB). Alternatively, the network nodes may be associated with different network entities. For example, as shown in FIG. 9, the first network node 904-1 may communicate with the UE1 902 in the uplink using an uplink receive (UL Rx) beam 906 at the network node 904-1 and an uplink transmit (UL Tx) beam 908 at the UE1 902. The second network node 904-2 may communicate with the UE1 902 in the downlink using a downlink transmit (DL Tx) beam 910 at the second network node 904-2 and a respective one of the corresponding downlink receive (DL Rx) beams 912 and 914 at the UE1 902.

In some aspects, the UL Tx beam 908 at the UE1 902 may be fixed (e.g., the direction and power of the UL Tx beam may be kept unchanged) and the SIM process may be performed first with the DL Rx beam 912 in order to obtain a first set of one or more SIM values, and thereafter with DL Rx beam 914 in order to obtain a second set of one or more SIM values. The dotted arrow, at 916, illustrates DL Rx beam sweeping for the SIM process which aims at determining which DL Rx beam to use For example, the UE1 902 may transmit via the UL Tx beam 908 ongoing SRS, DM-RS, PUCCH, PUSCH signals to the first network node 904-1, which may be received at the DL Rx beams 912 and 914 (e.g., directly as radio frequency (RF) leakage and/or indirectly as echo from nearby reflectors (not shown)).

In some aspects, the UL Tx beam 908 may be associated with a first antenna panel at the UE1 902 (e.g., antenna panel 804 shown in FIG. 8) and the DL Rx beams 912 and 914 may be associated with a second antenna panel of the UE1 902 (e.g., antenna panel 806 in FIG. 8) or with a second and a third antenna panel of the UE1 (e.g., antenna panels 806 and 808 in FIG. 8).

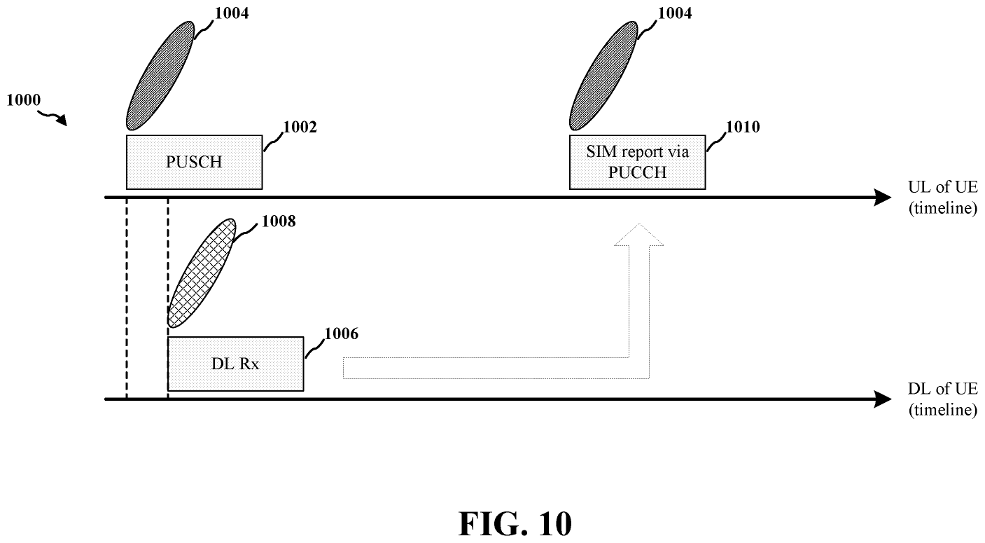

FIG. 10 shows a diagram 1000 illustrating an aspect of a baseline option for performing a self-interference measurement (SIM) procedure/process at a user equipment (UE). The UE may be the UE1 902 of FIG. 9 or a UE shown in any of the previous figures. According to this non-limiting example, the UE may transmit PUSCH signal(s) 1002 via UL Tx beam 1004 from a first antenna panel of the UE and may receive and measure the leaked (and/or reflected) signal(s) 1006 via the DL Rx beam 1008 at a second antenna panel of the UE. For example, the DL Rx beam 1008 may correspond to the latest active PDSCH beam. In some aspects, the UE may use a DL Rx timing-based scheme (which will be described subsequently in more detail), and there may be a single UL Tx occasion across all component carriers (CCs). The UE may transmit a SIM report 1010 (e.g., to a network entity) comprising a set of one or more SIM measurements via the PUCCH using the (same) UL Tx beam 1004. In some aspects, the SIM report 1010 may comprise one or more of: a beam ID, a SI metric, a time offset of the report, or an identification of the measured UL occasion.

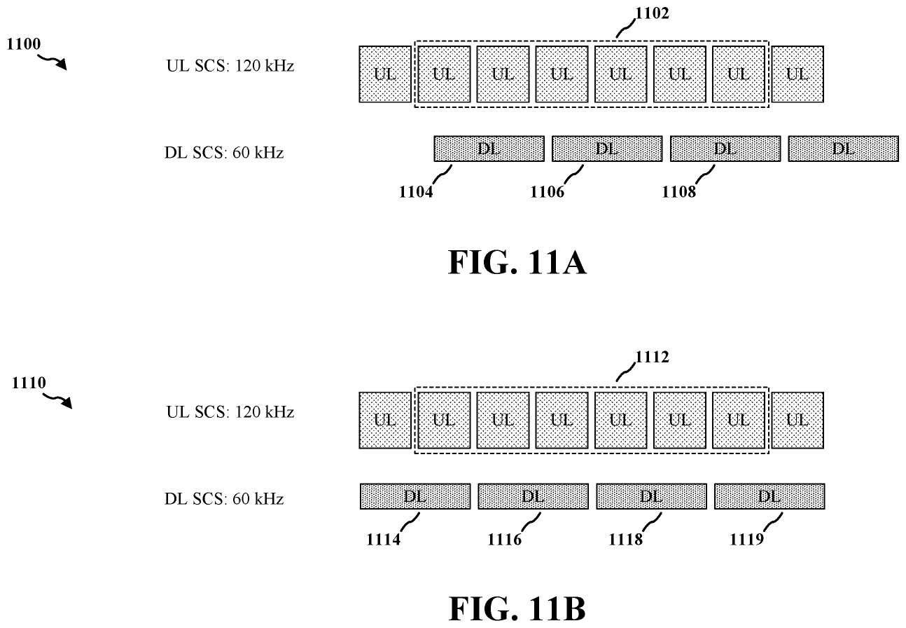

FIGS. 11A-11B illustrate two non-limiting examples of timing schemes in accordance with one or more aspects of the present disclosure. These timing schemes and the corresponding self-interference measurement (SIM) procedures and processes may be used in the context of any of the previous or following figures, in accordance with one or more aspects of the present disclosure. According to some aspects, illustrated in the diagram 1100 of FIG. 11A, the self-interference measurement (SIM) process at the UE may be based on downlink receive (DL Rx) timing. For example, as illustrated at 1102 by the dotted-line rectangle, the UL transmission may occupy six UL symbols and may be based on a subcarrier spacing (SCS) of 120 kHz (however, other SCSs are also contemplated in the present disclosure). The downlink (DL) symbols used for measuring the self-interference (SI) may correspond to a downlink (DL) beam and may be using a different subcarrier spacing (SCS) of 60 kHz (however, other SCSs are also contemplated in the present disclosure). In some aspects, the DL symbols selected for performing the SIM procedure may be fully overlapping with the six UL symbols (e.g., the first DL symbol 1104 and the second DL symbol 1106, from left to right, as shown in FIG. 11A). Alternatively, the DL symbols for performing the SIM procedure may be partially overlapping with the six UL symbols (e.g., the first DL symbol 1104, the second DL symbol 1106, and the third DL symbol 1108, from left to right, as shown in FIG. 11A).

FIG. 11B illustrates in the diagram 1110 some aspects of performing the SIM process based on uplink transmit (UL Tx) timing. Due to timing advance (TA) between downlink and uplink, the DL and UL timing is not aligned. For example, as shown at 1112, the UL transmission may occupy six UL symbols and may be based on a subcarrier spacing (SCS) of 120 kHz (however, other SCSs are also contemplated in the present disclosure). The DL symbols selected for performing the SIM process may correspond to a subcarrier spacing (SCS) of 60 kHz (however, other SCSs are also contemplated in the present disclosure). Only the DL symbols fully overlapping with the six UL symbols may be selected (e.g., the second DL symbol s 1116 and the third DL symbol 1118, from left to right, as shown in FIG. 11B). Alternatively, the SIM may be measured using DL symbols which are only partially overlapping with the six UL symbols (e.g., the first DL symbol 1114, the second DL symbol 1116, the third DL symbol 1118, the fourth DL symbol 1119, from left to right, shown in FIG. 11B). The examples illustrated in FIG. 11A and FIG. 11B do not limit the disclosure and other combinations (e.g., number of UL symbols, SCSs, etc.) are also contemplated.

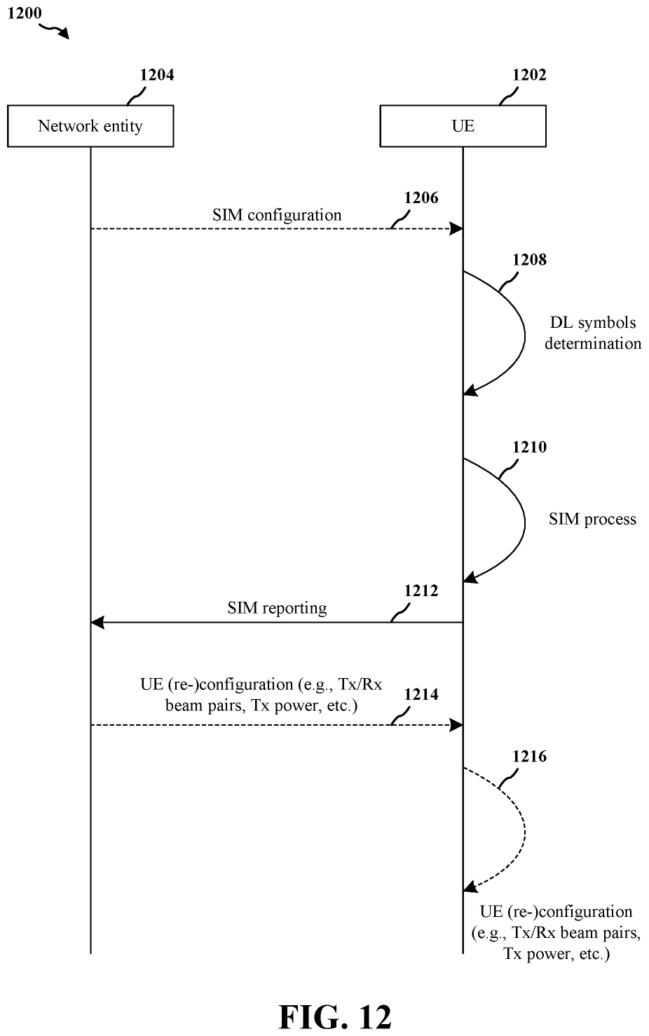

FIG. 12 shows a call flow diagram 1200 between a UE 1202 and a network entity 1204. Optional aspects are illustrated with a dashed line. The network entity 1204 may provide a cell serving UEs 802, 804, 806. For example, in the context of FIG. 1, the base station 1204 may correspond to the base station 102/180 and, accordingly, the cell may include a geographic coverage area 110 in which communication coverage is provided and/or small cell 102′ having a coverage area 110′. Further, the UE 1202 may correspond to at least UE 104. In another example, in the context of FIG. 4, the network entity 1204 may correspond to the base station 410 and the UE 1202 may correspond to the UE 450. In the context of FIG. 9, the UE 1202 may correspond to UE1 902, and the network entity 1204 may correspond to the first network node 904-1 or to the second network node 904-2. In some aspects, the network entity 1204 may correspond to a network entity (not shown in FIG. 9) which is associated with both the first and the second network nodes 904-1 and 904-2. For example, the network entity 1204 in the diagram 1200 may correspond to a base station (e.g., gNB) associated with the first and second TRPs 904-1 and 904-2 (e.g., first and second gNB-DUs) in FIG. 9.

As illustrated in FIG. 12, the network entity 1204 may configure at 1206 the UE 1202 for a self-interference measurement (SIM) process 1210. However, in some aspects, the UE 1202 may perform the SIM process 1210 according to a baseline configuration or option (e.g., without receiving a configuration from the network entity 1204). The baseline configuration may save overhead (see, e.g., FIG. 9). In related aspects, the network entity 1204 may configure a set of neighbor UEs for a cross-link interference (CLI) process (not shown). In some aspects, the network entity 1204 may configure the UE 1202 to perform the SIM process 1210 concurrently with the CLI process. The CLI process, configured from the network entity 1204, may configure each UE of the set of neighbor UEs to receive SRS from the UE 1202 as part of the CLI process, wherein the network entity 1204 may receive a CLI measurement report from each UE of the set of neighbor UEs (not shown). The SRS from the UE 1202 may be received by one or more beams of the one or more UEs of the set of neighbor UEs (not shown).

In some aspects, as part of the SIM configuration 1206 transmitted by the network entity 1204 and received by the UE 1202, the UE 1202 may also be configured to determine a subset of Rx beams based on a beam measurement process, as shown in the diagram 800 of FIG. 8. Each Rx beam of the subset of Rx beams may be associated with one antenna array panel of a plurality of different antenna array panels. In some aspects, the beam measurement process may comprise the UE 1202 receiving, from the network entity 1204, reference signals (RS) at each Rx beam of the plurality of different antenna array panels. Each Rx beam may be associated with a Tx beam from the network entity 1204. In some aspects, the subset of Rx beams determined from the beam measurement process may be the top candidate beams, selected based on the beam measurement process, used for a sweeping through the SRS (e.g., SIM process 1210). Additionally, or alternatively, the SIM configuration at 1206 may configure the UE 1202 to determine the set of DL symbols at 1208, based either on DL Rx timing or UL Tx timing, as disclosed in relation with FIGS. 11A-11B. The DL symbols determined at 1208 may be used by the UE 1202 for the SIM process at 1210.

In some aspects, the SIM process at 1210 may be performed by the UE 1202 as disclosed exemplarily in relation with FIG. 8 and/or FIG. 9. For example, the UE 1202 may transmit the SRS from an UL Tx beam of an antenna array panel of the UE 1202, which will be received (e.g., in a sweeping manner) at each DL Rx beam of one or more different antenna array panels of the UE 1202. In related aspects, the SRS may also be transmitted such as to be received by the beams of one or more neighbor UEs in a cross-link interference (CLI) measurement process. For example, the UE 1202 may transmit the SRS to one or more beams of neighbor UEs (not shown).

The UE 1202 may measure a self-interference based on the received SRS. For example, the UE 1202 may measure for at least one pair of the Tx/Rx beams of the subset of beams to be used in full duplex (FD) communication. In some aspects, the UE 1202 may perform FD by transmitting an uplink signal on an UL Tx beam from one antenna array panel while receiving a downlink signal on a DL Rx beam from a different antenna array panel. For example, the pair of UL Tx/DL Rx beams having the least amount of self-interference (SI) based on the received SRS, may be determined as a pair of UL Tx/DL Rx beams that the UE 1202 may use for FD. In related aspects, the pair of UL Tx/DL Rx beams may be determined based on the amount of SI, as represented by the SIM values, satisfying a certain threshold (e.g., being less than the threshold), wherein the threshold may be either predetermined or configurable. In further related aspects, the pair of UL Tx/DL Rx beams may be determined based at least in part on criteria accounting for the CLI measurements.

At 1212, the UE 1202 may report the selected one or more pairs of UL Tx/DL Rx beams to the network entity 1204. In some aspects, the UE 1202 may select M pairs of UL Tx/DL Rx beams, where the number of M pairs of UL Tx/DL Rx beams reported to the network entity 1204 may be any number, and in some instances may include “0” (“zero”, “null”, “void”), such that the UE may indicate in the SIM reporting at 1112 to the network entity 1204 that no pairs of UL Tx/DL Rx beams are available for use by the UE 1202 for FD communications with the network entity 1204.

In some aspects, measuring the self-interference by the UE 1202, at 1210, may comprise determining at least one of a reference signal received power (RSRP) of the received SRS or a reference signal strength indicator (RSSI) of the received SRS. In some aspects, the UE 1202 may also report a panel identifier (ID) associated with each Rx beam of the subset of beams. Reporting the panel ID associated with each Rx beam to the network entity, may assist the network entity 1212 in configuring the UE 1102 for self-interference measurements, such that an UL Tx beam and/or a DL Rx beam may not be scheduled to measure self-interference measurements if both the UL Tx beam and DL Rx beam are on the same panel.

In some aspects, the UE 1202 may receive, from the network entity 1204, a configuration for a transmission power of the SRS, wherein the SRS is transmitted at a power in accordance with the received configuration. For example, the UE 1202 may receive the configuration for the transmission power of the SRS within the configuration for the SIM process 1210. In some aspects, the configuration for the transmission power of the SRS may include an indicator for a full SRS Tx power or a reduced SRS Tx power. The reduced SRS Tx power may be reduced based on a ratio (e.g., dBm) or a percentage of the full SRS Tx power.

In some aspects, the configuration for the transmission power of the SRS may further include a CLI indicator to indicate whether the transmission of the SRS is for a real CLI measurement process or other measurement processes. In some related aspects, the CLI indicator indicating a real CLI measurement process may configure the SRS transmission to be at full SRS Tx power. The CLI indicator indicating the other measurement processes may configure the SRS transmission to be at a reduced SRS Tx power. The reduced SRS Tx power may be utilized to conduct self-interference measurements, such that the UE may scale up the reduced SRS Tx power to calculate the RSRP accordingly.

In some aspects, the UE 1202 may receive, from the base station 1204, a quasi-co location (QCL) configuration. The QCL configuration may indicate that each Rx beam of the subset of Rx beams is associated with an SRS resource for transmission. The transmission of the SRS resource may be repeated to each one of the Rx beams in a sweeping manner (e.g., as part of SIM process 1210) based on the QCL configuration. In some aspects, the UE 1202 may receive the QCL configuration within an SRS resource configuration or within an Rx measurement configuration for SRS-RSRP. For example, the UE 1202 may receive the QCL configuration within the configuration for the SIM process 1210. The Rx measurement configuration for SRS-RSRP may indicate a full or a reduced transmission (Tx) power, wherein the reduced Tx power may be based on a ratio or a percentage of the full Tx power.

In some aspects, the UE 1202 may receive, from the network entity 1204, a configuration indicating one or more UL Tx beams from which to transmit SRS and one or more DL Rx beams on which to receive the transmitted SRS, such that the sweeping through the transmission of the SRS and the reception of the SRS is based on the received configuration. In some aspects, the UE 1202 may receive, from the network entity 1204, the configuration indicating the Tx beams to transmit SRS and Rx beams to receive the transmitted SRS within the SIM configuration 1206 for the SIM process 1210. Each SRS may be repeatedly transmitted, to sweep the Rx beams, and a plurality of SRS may be repeatedly transmitted to sweep through the Tx beams.

Although the SIM report, at 1212, may comprise an indication of the pair(s) of beams selected by the UE 1202, in some cases, the SIM report 1212 may comprise only the “raw” results of the SIM process 1210, for example, in terms of a set of one or more SI measurement values. Therefore, in some aspects, the network entity 1204 may select a Tx beam/Rx beam pair with the UE 1202 based at least in part on the SIM reporting 1212 (and, if available, based on the CLI report from each UE of the set of neighbor UEs). The network entity 1104 may send an indication, at 1214, to the UE 1102 of a configuration (or reconfiguration), comprising at least the selected UL Tx beam/DL Rx beam pair to be used by the UE 1202. The UL Tx beam/DL Rx beam pair selected by the network entity 1204 may be utilized by the UE 1202 to perform FD communications with the network entity 1204. In some aspects, the selection of the UL Tx beam/DL Rx beam may be based on the top one or more uplink and downlink beams pairs having the lowest cross-beam RSRP and/or CLI SRS-RSRP indicated by the UE 1202. In related aspects, the selection of the UL Tx/DL Rx beam pair may be based on the SIM report and/or the CLI measurement reports, such that the network entity 1204 may consider both reports to determine the beam pair selection.

As shown in FIG. 12, based on the indication of a configuration (or reconfiguration), received at 1214 from the network entity 1204, the UE 1202 may further perform, at 1216, a configuration process with at least the indicated UL Tx/DL Rx beam pair, Tx power, and so on, for performing FD communications with the network entity 1204.

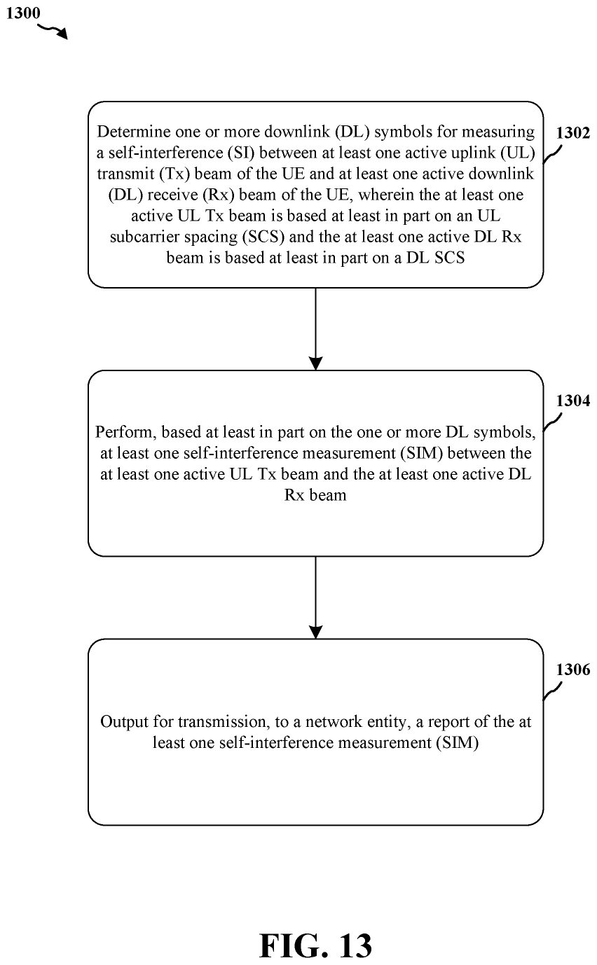

FIG. 13 is a flowchart 1300 of a process of wireless communication. The process may be performed by a component of a UE or by a UE (e.g., the UE 104, 502, 508, 602, 702-1, 902; the device 450; a processing system, which may include the memory and components configured to perform each of the blocks of the process, and which may be the entire UE or a component of the UE, such as the TX processor 468, the RX processor 456, and/or the controller/processor 459 shown in FIG. 4). According to various aspects, one or more of the illustrated operations of the process 1300 may be omitted, transposed, and/or simultaneously performed. Optional aspects, if any, may be illustrated with a dashed line. The process 1300 may enable a UE to perform a self-interference measurement (SIM) between at least one active UL Tx beam and at least one active DL Rx beam based on one or more DL symbols. The result of the SIM may be transmitted to a network entity. The SIM reporting may comprise one or more UL Tx/DL Rx beam pairs suitable for full duplex communication at the UE with the network entity. Alternatively, or additionally, the SIM reporting may enable the network entity to determine the one or more UL Tx/DL Rx beam pairs and, in some cases, configure the UE to use the one or more beam pairs.

At 1302, the process 1300 may comprise: determining one or more downlink (DL) symbols for measuring a self-interference (SI) between at least one active uplink (UL) transmit (Tx) beam of the UE and at least one active downlink (DL) receive (Rx) beam of the UE, wherein the at least one active uplink (UL) transmit (Tx) beam is based at least in part on an uplink (UL) subcarrier spacing (SCS), and the at least one active downlink (DL) receive (Rx) beam is based at least in part on a downlink (DL) subcarrier spacing (SCS). At 1304, the process 1300 may comprise: performing, based at least in part on the one or more downlink (DL) symbols, at least one self-interference measurement (SIM) between the at least one active uplink (UL) transmit (Tx) beam and the at least one active downlink (DL) receive (Rx) beam. At 1306, the process 1300 may comprise: outputting for transmission (or transmitting) to a network entity, a report of the at least one self-interference measurement (SIM). For example, if the process is performed by a component of the UE, then the process comprises, at 1306, outputting for transmission by the UE, and if the process is performed by the UE then the process comprises, at 1206, transmitting by the UE.

The self-interference (SI) may be caused by radio frequency (RF) leakage between the UL Tx beam and the DL RX beam of the UE, in which case it is referred to as “leaked” self-interference. Additionally, or alternatively, the self-interference (SI) may be caused by reflections/echo from one or more nearby reflectors of the signal transmitted via the UL Tx beam by the UE, which is received indirectly as clutter echo at the DL Rx beam, in which case it is referred to as “clutter echoed” self-interference. In this disclosure, we may use only the general term “self-interference” to refer to either one or both types of “leaked” and “clutter echoed” self-interference.

In some aspects, the process 1300 may further comprise: determining the at least one active uplink (UL) transmit (Tx) beam for transmitting at least one of uplink (UL) data or uplink (UL) control information to a first network node via a first antenna array panel of the UE; and determining the at least one active downlink (DL) receive (Rx) beam for receiving at least one of downlink (DL) data or downlink (DL) control information from a second network node via a second antenna array panel of the UE.

In some aspects, determining the at least one active UL Tx beam comprises selecting the at least one active UL Tx beam. In some aspects, determining the at least one active DL Rx beam comprises selecting the at least one active DL Rx beam. In some aspects, determining the one or more DL symbols comprises selecting the one or more DL symbols. In some aspects, determining the at least one active UL Tx beam comprises receiving an indication of the at least one active UL Tx beam from the network entity. In some aspects, determining the at least one active DL Rx beam comprises receiving an indication of the at least one active DL Rx beam from the network entity. In some aspects, determining the one or more DL symbols comprises receiving an indication of the one or more DL symbols from the network entity.

In some aspects, the at least one active uplink (UL) transmit (Tx) beam and the at least one active downlink (DL) receive (Rx) beam may be associated with a full duplex (FD) communication mode of the UE. In some aspects, the uplink (UL) subcarrier spacing (SCS) may be different from the downlink (DL) subcarrier spacing (SCS). In some aspects, the first network node and the second network node may be associated with the network entity. In some aspects, the first network node and the second network node may be transmitter receiver points (TRPs), and the network entity may be a giga Node B (gNB). In some aspects, the first network node and the second network node may be different network nodes. In some aspects, the first network node and the second network node may be a same network node.

In some aspects, the process 1300 may further comprise: obtaining, from the network entity, an indication of a selected pair of the at least one active uplink (UL) transmit (Tx) beam and the at least one active downlink (DL) receive (Rx) beam for a full duplex (FD) communication mode of the UE based at least in part on a value of the at least one self-interference measurement (SIM) satisfying a threshold (e.g., the SIM value being less than a predetermined, or in some cases configurable, threshold).

In some aspects, the one or more downlink (DL) symbols for measuring the self-interference (SI) may be determined based at least in part on a configuration. In some aspects, the configuration may comprise one of: an indication of a downlink (DL) receive (Rx) timing scheme; or an indication of an uplink (UL) transmit (Tx) timing scheme (e.g., such as the timing schemes 1100 and/or 1110 described in connection with FIGS. 11A-11B). In some aspects, the configuration may comprise one of: an indication that the one or more downlink (DL) symbols of the at least one active downlink (DL) receive (Rx) beam at least partially overlap in time with one or more uplink (UL) symbols of the at least one active uplink (UL) transmit (Tx) beam; or an indication that the one or more downlink (DL) symbols of the at least one active downlink (DL) receive (Rx) beam fully overlap in time with one or more uplink (UL) symbols of the at least one active uplink (UL) transmit (Tx) beam. In some aspects, the configuration may comprise: an indication of the one or more uplink (UL) symbols of the at least one active uplink (UL) transmit (Tx) beam. In some aspects, the process 1200 may further comprise: obtaining, from the network entity, an indication of the configuration. In some aspects, the configuration may be predefined. In some aspects, the configuration may be selected by the user equipment (UE).

In some aspects, the process 1300 may further comprise: performing the at least one self-interference measurement (SIM) based on a per bandwidth part (BWP) and per component carrier (CC). In some aspects, the downlink (DL) subcarrier spacing (SCS) may be determined per downlink (DL) bandwidth part (BWP) per downlink (DL) component carrier (CC).

In some aspects, the downlink (DL) subcarrier spacing (SCS) may be determined as a common downlink (DL) subcarrier spacing (SCS) for all configured downlink (DL) bandwidth parts (BWPs) per downlink (DL) component carrier (CC). In some aspects, the common downlink (DL) subcarrier spacing (SCS) may be one of: a smallest subcarrier spacing (SCS) of all configured downlink (DL) bandwidth parts (BWPs) per downlink (DL) component carrier (CC); or a largest subcarrier spacing (SCS) of all configured downlink (DL) bandwidth parts (BWPs) per downlink (DL) component carrier (CC).

In some aspects, the process 1300 may further comprise: performing the at least one self-interference measurement (SIM) based on a per component carrier (CC) irrespective of a bandwidth part (BWP). In some aspects, the downlink (DL) subcarrier spacing (SCS) may be determined per downlink (DL) component carrier (CC) as a downlink (DL) subcarrier spacing (SCS) of an active downlink (DL) bandwidth part (BWP) of the downlink (DL) component carrier (CC).

In some aspects, the process 1300 may further comprise: performing the at least one self-interference measurement (SIM) based on a number (N) of resource blocks (RBs) of a downlink (DL) receive (Rx) bandwidth (BW) adjacent to an uplink (UL) transmit (Tx) bandwidth (BW). In some aspects, the downlink (DL) subcarrier spacing (SCS) may be determined as a common downlink (DL) subcarrier spacing (SCS) for all active downlink (DL) bandwidth parts (BWPs) of all downlink (DL) component carriers (CCs) in the downlink (DL) receive (Rx) bandwidth (BW). In some aspects, the common downlink (DL) subcarrier spacing (SCS) may be one of: a smallest downlink (DL) subcarrier spacing (SCS) of all configured downlink (DL) bandwidth parts (BWPs) of all component carriers (CCs) in the downlink (DL) receive (Rx) bandwidth (BW); or a largest downlink (DL) subcarrier spacing (SCS) of all configured downlink (DL) bandwidth parts (BWPs) of all component carriers (CCs) in the downlink (DL) receive (Rx) bandwidth (BW).

The process 1300 in FIG. 13, including one or more aspects described in the foregoing, may be performed by an apparatus that includes components configured to perform each of the blocks of the algorithm in the aforementioned flowchart of FIG. 13 and/or the aspects described in connection with the UE 1202 in FIG. 12. As such, each block in the aforementioned flowchart of FIG. 13 and/or the aspects described in connection with FIG. 12 and/or FIG. 13 may be performed by a component and the apparatus may include one or more of those components. The components may be one or more hardware components specifically configured to carry out the stated processes/algorithm, implemented by at least one processor (e.g., controller/processor 459, RX processor 456, and/or TX processor 468 with reference to FIG. 4) configured to perform the stated processes/algorithm, stored within a computer-readable medium (e.g., memory 460) storing computer executable code that-when executed by a processor-instruct the processor to perform aspects of FIG. 12 and/or FIG. 13, or some combination thereof. At least some of the operations described in connection with FIG. 12 and/or FIG. 13 may be performed at least in part by the self-interference measurement (SIM) component 198 illustrated in FIG. 1 as part of the UE 104.

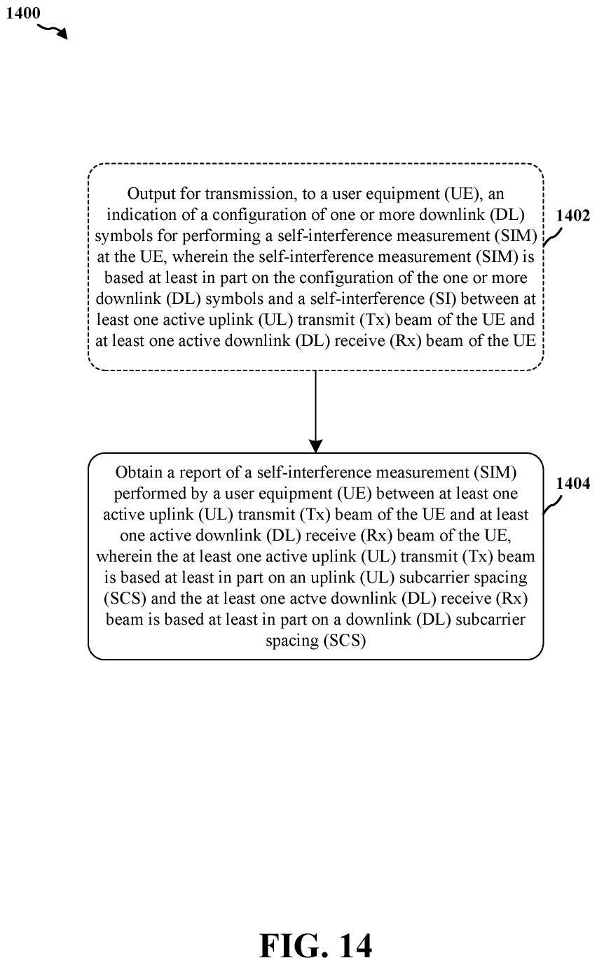

FIG. 14 is a flowchart 1400 of a process of wireless communication. The process may be performed by a network entity or one or more components of a network entity (e.g., the base station 102, 180, 504, 510, 604, 604-1, 604-2, 704-1, 904-1, 904-2; the device 410; a processing system, which may include the memory and component configured to perform each of the blocks of the process, and which may be the entire base station or a component of the base station, such as the TX processor 416, the RX processor 470, and/or the controller/processor 475 shown in FIG. 4). According to various aspects, one or more of the illustrated operations of the process 1400 may be omitted, transposed, and/or performed simultaneously. Optional aspects are illustrated with a dashed line. The process may enable a network entity to configure a UE to determine UL Tx/DL Rx beam pairs suitable for full duplex (FD) communication, based at least in part on a self-interference measurement (SIM) procedure.

In some (optional) aspects, at 1402, the network entity may transmit (and/or a component of the network entity may output for transmission), to a user equipment (UE), an indication of a configuration of one or more downlink (DL) symbols for performing a self-interference measurement (SIM) procedure at the UE, wherein the SIM procedure is based at least in part on the configuration of the one or more downlink (DL) symbols and a self-interference (SI) between at least one active uplink (UL) transmit (Tx) beam and at least one active downlink (DL) receive (Rx) beam of the UE. In some aspects, the one or more DL symbols may correspond to the one or more DL symbols determined by the UE at 1302 in FIG. 13.

The self-interference (SI) may be caused by radio frequency (RF) leakage between the UL Tx beam and the DL RX beam of the UE, in which case it is referred to as “leaked” self-interference. Additionally, or alternatively, the self-interference (SI) may be caused by reflections/echo from one or more nearby reflectors of the signal transmitted via the UL Tx beam by the UE, which is received indirectly as clutter echo at the DL Rx beam, in which case it is referred to as “clutter echoed” self-interference. In this disclosure, we may use only the general term “self-interference” to refer to either one or both types of “leaked” and “clutter echoed” self-interference.

At 1404, the network entity may receive (and/or a component of the network entity may obtain) from the UE a report of the SIM procedure, performed by the UE, between the at least one active uplink (UL) transmit (Tx) beam of the UE and the at least one active downlink (DL) receive (Rx) beam of the UE; wherein the at least one active uplink (UL) transmit (Tx) beam is based at least in part on an uplink (UL) subcarrier spacing (SCS), and the at least one active downlink (DL) receive (Rx) beam is based at least in part on a downlink (DL) subcarrier spacing (SCS).

In some aspects, the report of the at least one SIM procedure obtained by the network entity at 1404 may correspond to the report transmitted at 1306 by the UE in FIG. 13, and the at least one SIM procedure may correspond to the procedure performed at 1304 in FIG. 13. In one or more related aspects, the process 1400 may comprise additional operations corresponding (reciprocally) to the operations associated with the one or more aspects described in connection with the process 1300 of FIG. 13.

In some aspects, the process 1400 may further comprise: outputting for transmission, to the UE, an indication of the at least one active uplink (UL) transmit (Tx) beam of the UE; and/or outputting for transmission, to the UE, an indication of the at least one active downlink (DL) receive (Rx) beam of the UE. In related aspects, the process 1400 may further comprise: outputting for transmission, to the UE, an indication of a beam configuration comprising at least one pair of an uplink (UL) transmit (Tx) beam and a corresponding downlink (DL) receive (Rx) beam to be utilized by the UE to perform full duplex communications with the network entity; wherein the beam configuration is based at least in part on the report of the self-interference measurement (SIM) received from the UE.

In some aspects, the network entity may be associated with at least a first network node and a second network node. In some aspects, the first network node and the second network node may be different network nodes. In some aspects, the first network node and the second network node may be a same network node. In some aspects, the network entity may be a giga Node B (gNB), and the first network node and the second network node may be transmitter receiver points (TPRs). In some aspects, the network entity may be a smallest component of a gNB, e.g., a gNB Central Unit (gNB-CU) or a part thereof, configured (or operable) to perform the method of any of the related aspects described herein, and the first and second network nodes may be, respectively, a smallest component of a respective TRP configured (or operable) to perform the method of any of the related aspects described herein. In some aspects, the network entity may be a gNB and the first network node and the second network node may be gNB Distributed Units (gNB-DUs). In some aspects, the network entity may be a smallest component of a gNB, such as gNB Central Unit (gNB-CU) or a part thereof, configured (or operable) to perform the method of any of the related aspects described herein, and the first and second network nodes may be, respectively, a smallest component of a respective gNB-DU configured (or operable) to perform the method of any of the related aspects described herein.

In some aspects, the process 1300 may further comprise: determining the at least one active uplink (UL) transmit (Tx) beam of the UE for the UE to transmit at least one of uplink (UL) data or uplink (UL) control information to a first network node via a first antenna array panel of the UE; and determining the at least one active downlink (DL) receive (Rx) beam of the UE for the UE to receive at least one of downlink (DL) data or downlink (DL) control information from a second network node via a second antenna array panel of the UE. In some aspects, the at least one active uplink (UL) transmit (Tx) beam of the UE and the at least one active downlink (DL) receive (Rx) beam of the UE may be associated with a full duplex (FD) communication mode of the user equipment (UE). In some aspects, the uplink (UL) subcarrier spacing (SCS) may be different from the downlink (DL) subcarrier spacing (SCS).

In some aspects, the process 1400 may further comprise: outputting for transmission, to the UE, an indication of a selected pair of the at least one active uplink (UL) transmit (Tx) beam and the at least one active downlink (DL) receive (Rx) beam for a full duplex (FD) communication mode of the UE based at least in part on a value of the at least one self-interference measurement (SIM) satisfying a threshold (condition). In some aspects, satisfying the threshold (condition) means that the at least one SIM value should be less than (or at most equal to) the threshold, wherein the threshold may be predefined or configurable. In related aspects, the indication of the selected pair may indicate that there is no pair of active UL Tx/DL Rx beams of the UE satisfying the threshold (condition).

In some aspects, the configuration of the one or more downlink (DL) symbols for performing the self-interference measurement (SIM) by the UE may comprises an indication of a downlink (DL) receive (Rx) timing scheme, or an indication of an uplink (UL) transmit (Tx) timing scheme, or both. In some aspects, the configuration of the one or more downlink (DL) symbols for performing the self-interference measurement (SIM) by the UE may comprise one of: an indication that the one or more downlink (DL) symbols of the at least one active downlink (DL) receive (Rx) beam at least partially overlap in time with one or more uplink (UL) symbols of the at least one active uplink (UL) transmit (Tx) beam; or an indication that the one or more downlink (DL) symbols of the at least one active downlink (DL) receive (Rx) beam fully overlap in time with one or more uplink (UL) symbols of the at least one active uplink (UL) transmit (Tx) beam. In some aspects, the configuration of the one or more downlink (DL) symbols for performing the self-interference measurement (SIM) by the UE may comprise an indication of the one or more uplink (UL) symbols of the at least one active uplink (UL) transmit (Tx) beam.

In some aspects, the process 1400 may further comprise: outputting for transmission, to the UE, an indication of a configuration for performing the at least one self-interference measurement (SIM) based on a per bandwidth part (BWP) and per component carrier (CC).

In some aspects, the downlink (DL) subcarrier spacing (SCS) may be determined per downlink (DL) bandwidth part (BWP) per downlink (DL) component carrier (CC). In some aspects, the downlink (DL) subcarrier spacing (SCS) may be determined as a common downlink (DL) subcarrier spacing (SCS) for all configured downlink (DL) bandwidth parts (BWPs) per downlink (DL) component carrier (CC). In some aspects, the common downlink (DL) subcarrier spacing (SCS) may be one of: a smallest subcarrier spacing (SCS) of all configured downlink (DL) bandwidth parts (BWPs) per downlink (DL) component carrier (CC); or a largest subcarrier spacing (SCS) of all configured downlink (DL) bandwidth parts (BWPs) per downlink (DL) component carrier (CC).

In some aspects, the process 1400 may further comprise: outputting for transmission, to the UE, an indication of a configuration for performing the at least one self-interference measurement (SIM) based on a per component carrier (CC) irrespective of a bandwidth part (BWP). In some aspects, the downlink (DL) subcarrier spacing (SCS) may be determined per downlink (DL) component carrier (CC) as a downlink (DL) subcarrier spacing (SCS) of an active downlink (DL) bandwidth part (BWP) of the downlink (DL) component carrier (CC).

In some aspects, the process 1400 may further comprise: outputting for transmission, to the UE, an indication of a configuration for performing the at least one self-interference measurement (SIM) based on a number (N) of resource blocks (RBs) of a downlink (DL) receive (Rx) bandwidth (BW) adjacent to an uplink (UL) transmit (Tx) bandwidth (BW).

In some aspects, the downlink (DL) subcarrier spacing (SCS) may be determined as a common downlink (DL) subcarrier spacing (SCS) for all active downlink (DL) bandwidth parts (BWPs) of all downlink (DL) component carriers (CCs) in the downlink (DL) receive (Rx) bandwidth (BW). In some aspects, the common downlink (DL) subcarrier spacing (SCS) may be one of: a smallest downlink (DL) subcarrier spacing (SCS) of all active downlink (DL) bandwidth parts (BWPs) of all downlink (DL) component carriers (CCs) in the downlink (DL) receive (Rx) bandwidth (BW); or a largest downlink (DL) subcarrier spacing (SCS) of all active downlink (DL) bandwidth parts (BWPs) of all downlink (DL) component carriers (CCs) in the downlink (DL) receive (Rx) bandwidth (BW).

In some aspects, the downlink (DL) subcarrier spacing (SCS) may be determined as a common downlink (DL) subcarrier spacing (SCS) for all configured downlink (DL) bandwidth parts (BWPs) of all downlink (DL) component carriers (CCs) in the downlink (DL) receive (Rx) bandwidth (BW). In some aspects, the common downlink (DL) subcarrier spacing (SCS) may be one of: a smallest downlink (DL) subcarrier spacing (SCS) of all configured downlink (DL) bandwidth parts (BWPs) of all component carriers (CCs) in the downlink (DL) receive (Rx) bandwidth (BW); or a largest downlink (DL) subcarrier spacing (SCS) of all configured downlink (DL) bandwidth parts (BWPs) of all component carriers (CCs) in the downlink (DL) receive (Rx) bandwidth (BW).

The process in FIG. 14 may be performed by an apparatus that includes components configured to perform each of the blocks of the algorithm in the aforementioned flowchart of FIG. 14 and/or aspects described in connection with the network entity 1204 in FIG. 12. As such, each block in the aforementioned flowchart of FIG. 14 and/or the aspects described in connection with FIG. 12 may be performed by a component and the apparatus may include one or more of those components. The components may be one or more hardware components specifically configured to carry out the stated processes/algorithm, implemented by at least one processor configured to perform the stated processes/algorithm (e.g., controller/processor 475, TX processor 416, and/or RX processor 470 with reference to FIG. 4), stored within a computer-readable medium (e.g., memory 476) storing computer executable code that—when executed by a processor—instruct the processor to perform aspects of FIG. 12 and/or FIG. 14, or some combination thereof. One or more aspects may be performed by the self-interference measurement (SIM) configuration component 199 of the network entity 102/180 illustrated in FIG. 1.

In related aspects, the network entity may have a distributed architecture, and the one or more aspects may be performed by one or more distributed components of the network entity. For example, the network entity may comprise one or more network nodes, for example, the network entity may be a gNB and the network nodes may be TRPs, such as gNB-DUs, which may correspond in some cases, to the TRPs 904-1 and 904-2 illustrated in FIG. 9. For example, with reference to FIG. 9, a first network node 904-1 (e.g., TRP, gNB-DU, and the like) may communicate with the UE1 902 on the uplink, and a second network node 904-2 (e.g., TRP, gNB-DU, and the like) may communicate with the UE2 902 on the downlink. In some aspects, as disclosed in connection with FIG. 13, the first and the second network nodes may be associated with the network entity. In some aspects, the first and the second network nodes may be different network nodes (e.g., TRPs 604-1 and 604-2 in FIG. 6A, TRPs 704-1 and 704-2 in FIG. 7C). In some related aspects, the first and the second network nodes may be the same network node (e.g., TRP 604 in FIG. 6C, TRP 704-1 in FIG. 7B).

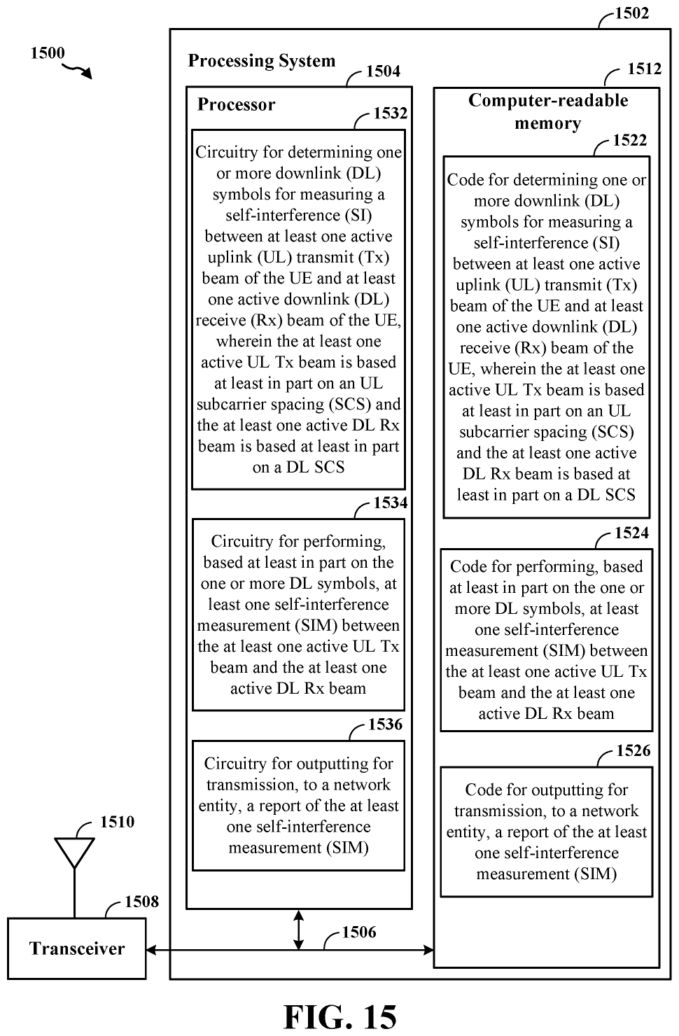

FIG. 15 illustrates a diagram of an apparatus 1500 for wireless communications at a user equipment (UE), the apparatus (e.g., the UE 104, 502, 508, 602, 702-1, 902; the device 450; a processing system, which may include the memory and components configured to perform each of the blocks of the process, and which may be the entire UE or a component of the UE, such as the TX processor 468, the RX processor 456, and/or the controller/processor 459) being configured (or operable) to perform one or more aspects described in connection with the process 1300 of FIG. 13.

In some aspects, the apparatus 1500 may comprise a processing system 1502, a transceiver 1508 and one or more antennas (or antenna panels) 1510. The processing system 1502 may comprise a processor 1504 and a computer-readable memory 1512, interconnected (e.g., electrically coupled) with each other via a bus system 1506, and further interconnected (e.g., electrically coupled) with the transceiver 1508.

In some aspects, as illustrated in FIG. 15, the processor 1504 may comprise circuitry 1532 for determining one or more downlink (DL) symbols for measuring a self-interference (SI) between at least one active uplink (UL) transmit (Tx) beam of the UE and at least one active downlink (DL) receive (Rx) beam of the UE; wherein the at least one active uplink (UL) transmit (Tx) beam is based at least in part on an uplink (UL) subcarrier spacing (SCS), and the at least one active downlink (DL) receive (Rx) beam is based at least in part on a downlink (DL) subcarrier spacing (SCS). In some aspects, the processor 1504 may further comprise circuitry for performing, based at least in part on the one or more downlink (DL) symbols, at least one self-interference measurement (SIM) between the at least one active uplink (UL) transmit (Tx) beam and the at least one active downlink (DL) receive (Rx) beam; and circuitry 1536 for outputting for transmission, to a network entity, a report of the at least one self-interference measurement (SIM). In some related aspects, the processor 1504 may comprise additional (or alternative) circuitry for implementing one or more aspects disclosed in connection with FIG. 12 and/or FIG. 13, and/or any of the related drawings described in the present application.

The self-interference (SI) may be caused by radio frequency (RF) leakage between the UL Tx beam and the DL RX beam of the UE, in which case it is referred to as “leaked” self-interference. Additionally, or alternatively, the self-interference (SI) may be caused by reflections/echo from one or more nearby reflectors of the signal transmitted via the UL Tx beam by the UE, which is received indirectly as clutter echo at the DL Rx beam, in which case it is referred to as “clutter echoed” self-interference. In this disclosure, we may use only the general term “self-interference” to refer to either one or both types of “leaked” and “clutter echoed” self-interference.

In some aspects, as illustrated in FIG. 15, the computer-readable memory 1512 may comprise code 1522 for determining one or more downlink (DL) symbols for measuring a self-interference (SI) between at least one active uplink (UL) transmit (Tx) beam of the UE and at least one active downlink (DL) receive (Rx) beam of the UE; wherein the at least one active UL Tx beam is based at least in part on an UL subcarrier spacing (SCS) and the at least one active DL Rx beam is based at least in part on a DL SCS. In some aspects, the computer-readable memory 1512 may further comprise code 1524 for performing, based at least in part on the one or more DL symbols, at least one self-interference measurement (SIM) between the at least one active UL Tx beam and the at least one active DL Rx beam; and code 1526 for outputting for transmission, to a network entity, a report of the at least one self-interference measurement (SIM). In some related aspects, the computer-readable memory 1512 may comprise additional (or alternative) code for implementing one or more aspects disclosed in connection with FIG. 12 and/or FIG. 13, and/or any of the related drawings described in the present application.

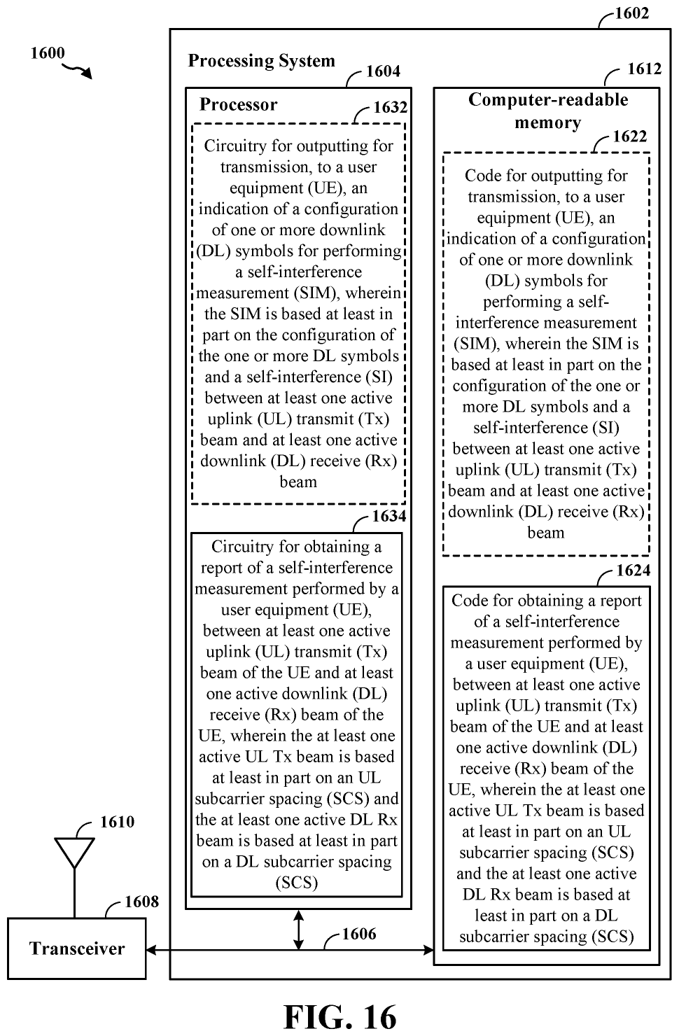

FIG. 16 illustrates a diagram of an apparatus 1600 for wireless communication at a network entity. The apparatus 1600 may be configured to perform one or more of the aspects described in connection with the process 1400 illustrated in FIG. 14.

In some aspects, the apparatus 1600 may comprise a processing system 1602, a transceiver 1608 and one or more antennas (or antenna panels) 1610. The processing system 1602 may comprise a processor 1604 and a computer-readable memory 1612, interconnected (e.g., electrically coupled) with each other via a bus system 1606, and further interconnected (e.g., electrically coupled) with the transceiver 1608.

In some aspects, as illustrated in FIG. 16, the processor 1604 may comprise (optionally, as indicated by the dotted line) a circuitry 1632 for outputting for transmission, to a user equipment (UE), an indication of a configuration of one or more downlink (DL) symbols for performing a self-interference measurement (SIM); wherein the SIM is based at least in part on the configuration of the one or more DL symbols and a self-interference (SI) between at least one active uplink (UL) transmit (Tx) beam and at least one active downlink (DL) receive (Rx) beam. In some aspects, the processor 1604 may comprise circuitry 1634 for obtaining a report of a self-interference measurement performed by a user equipment (UE), between at least one active uplink (UL) transmit (Tx) beam of the UE and at least one active downlink (DL) receive (Rx) beam of the UE; wherein the at least one active UL Tx beam is based at least in part on an UL subcarrier spacing (SCS) and the at least one active DL Rx beam is based at least in part on a DL subcarrier spacing (SCS). In some related aspects, the processor 1604 may comprise additional (or alternative) circuitry for implementing one or more aspects disclosed in connection with FIG. 12 and/or FIG. 14, and/or any of the related drawings described in the present application.

The self-interference (SI) may be caused by radio frequency (RF) leakage between the UL Tx beam and the DL RX beam of the UE, in which case it is referred to as “leaked” self-interference. Additionally, or alternatively, the self-interference (SI) may be caused by reflections/echo from one or more nearby reflectors of the signal transmitted via the UL Tx beam by the UE, which is received indirectly as clutter echo at the DL Rx beam, in which case it is referred to as “clutter echoed” self-interference. In this disclosure, we may use only the general term “self-interference” to refer to either one or both types of “leaked” and “clutter echoed” self-interference.

In some aspects, as illustrated in FIG. 16, the computer-readable memory 1612 may comprise (optionally, as indicated by the dotted line) code 1622 for outputting for transmission, to a user equipment (UE), an indication of a configuration of one or more downlink (DL) symbols for performing a self-interference measurement (SIM); wherein the SIM is based at least in part on the configuration of the one or more DL symbols and a self-interference (SI) between at least one active uplink (UL) transmit (Tx) beam and at least one active downlink (DL) receive (Rx) beam. In some aspects, the computer-readable memory 1612 may comprise code 1624 for obtaining a report of a self-interference measurement performed by a user equipment (UE), between at least one active uplink (UL) transmit (Tx) beam of the UE and at least one active downlink (DL) receive (Rx) beam of the UE; wherein the at least one active UL Tx beam is based at least in part on an UL subcarrier spacing (SCS) and the at least one active DL Rx beam is based at least in part on a DL subcarrier spacing (SCS). In some related aspects, the computer-readable memory 1612 may comprise additional (or alternative) code for implementing one or more aspects disclosed in connection with FIG. 12 and/or FIG. 14, and/or any of the related drawings described in the present application.

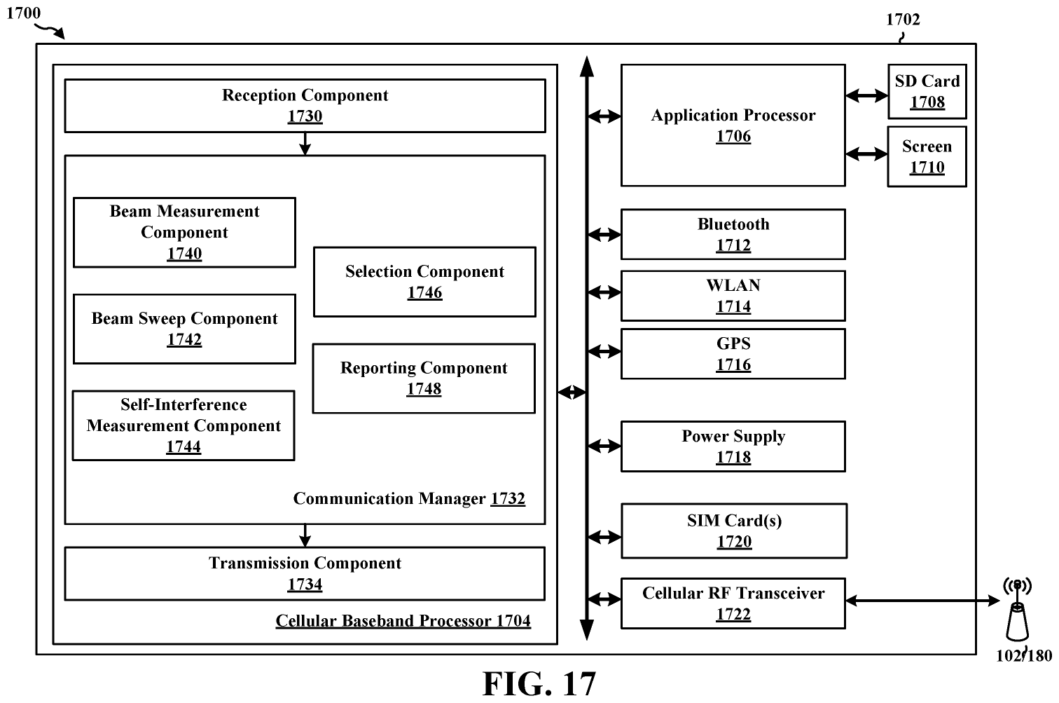

FIG. 17 is a diagram 1700 illustrating an example of a hardware implementation for an apparatus 1702. The apparatus 1702 may be a UE or other wireless device that may communicate based on Uu direct link. Additionally, or alternatively, the apparatus 1702 may communicate using a sidelink, such as a PC5 interface.

The apparatus 1702 may include a cellular baseband processor 1704 (also referred to as a modem) coupled to a cellular RF transceiver 1722 and one or more subscriber identity modules (SIM) cards 1720, an application processor 1706 coupled to a secure digital (SD) card 1708 and a screen 1710, a Bluetooth module 1712, a wireless local area network (WLAN) module 1714, a Global Positioning System (GPS) module 1716, and a power supply 1718. The cellular baseband processor 1704 may communicate through the cellular RF transceiver 1722 with other wireless devices, such as other UE 104 and/or a network entity (or base station) 102/180, as illustrated in FIG. 1.

The cellular baseband processor 1704 may include a computer-readable medium/memory (not shown). The cellular baseband processor 1704 may be responsible for general processing, including the execution of software stored on the computer-readable medium/memory. The software, when executed by the cellular baseband processor 1704, may cause the cellular baseband processor 1704 to perform one or more of the various aspects described supra. The computer-readable medium/memory may also be used for storing data that is manipulated by the cellular baseband processor 1704 when executing software. The cellular baseband processor 1704 may further include a reception component 1730, a communication manager 1732, and a transmission component 1734. The communication manager 1732 may include the one or more illustrated components. The components within the communication manager 1732 may be stored in the computer-readable medium/memory (not shown) and/or configured as hardware within the cellular baseband processor 1704. The cellular baseband processor 1704 may be a component of the UE 450 shown in FIG. 4 and may include the memory 460 and/or at least one of the TX processor 468, the RX processor 456, and the controller/processor 459 (all shown in FIG. 4). In one configuration, the apparatus 1702 may be a modem chip and include just the baseband processor 1704, and in another configuration, the apparatus 1702 may be the entire wireless device (e.g., see the UE 450 of FIG. 4) and include additional modules of the apparatus 1702. In some aspects, the communication manager 1732 may include a beam measurement component 1740, a beam sweep component 1742, a self-interference measurement (SIM) component 1744 (which may correspond to the SIM component 198 illustrated, for example, in FIGS. 1, 2, and 4), a selection component 1746 and/or a reporting component 1748 configured or operable to perform one or more aspects described in connection with one or more of the previous drawings/figures, including but not limited to FIGS. 8, 9, 10, 12, 13, and 15. The apparatus 1702 is illustrated as including various components to perform the functions for the wireless device to operate as a transmitting device at times and as a receiving device at other times. The apparatus 1702 may include additional components that are configured (and/or operable) to perform each of the aspects in the aforementioned drawings, diagrams and flowcharts. The components may be one or more hardware components specifically configured to carry out the stated processes/algorithm, implemented by a processor configured to perform the stated processes/algorithm, stored within a computer-readable medium for implementation by a processor, or some combination thereof.

The apparatus 1702 may include means for determining one or more downlink (DL) symbols for measuring a self-interference (SI) between at least one active uplink (UL) transmit (Tx) beam of the UE and at least one active downlink (DL) receive (Rx) beam of the UE; wherein the at least one active uplink (UL) transmit (Tx) beam is based at least in part on an uplink (UL) subcarrier spacing (SCS), and the at least one active downlink (DL) receive (Rx) beam is based at least in part on a downlink (DL) subcarrier spacing (SCS); means for performing, based at least in part on the one or more downlink (DL) symbols, at least one self-interference measurement (SIM) between the at least one active uplink (UL) transmit (Tx) beam and the at least one active downlink (DL) receive (Rx) beam; and means for outputting for transmission, to a network entity, a report of the at least one self-interference measurement (SIM).

The self-interference (SI) may be caused by radio frequency (RF) leakage between the UL Tx beam and the DL RX beam of the UE, in which case it is referred to as “leaked” self-interference. Additionally, or alternatively, the self-interference (SI) may be caused by reflections/echo from one or more nearby reflectors of the signal transmitted via the UL Tx beam by the UE, which is received indirectly as clutter echo at the DL Rx beam, in which case it is referred to as “clutter echoed” self-interference. In this disclosure, we may use only the general term “self-interference” to refer to either one or both types of “leaked” and “clutter echoed” self-interference.

The apparatus 1702 may comprise further means for implementing one or more aspects disclosed at least in connection with FIG. 12 and/or FIG. 13. The aforementioned means may be one or more of the aforementioned components of the apparatus 1702 configured to perform the functions recited by the aforementioned means. For example, the aforementioned means may be part of the communication manager 1732. As described supra, the apparatus 1702 may include the TX Processor 468, the RX Processor 456, and the controller/processor 459. As such, in one configuration, the aforementioned means may be the TX Processor 468, the RX Processor 456, and the controller/processor 459 configured to perform the functions recited by the aforementioned means.

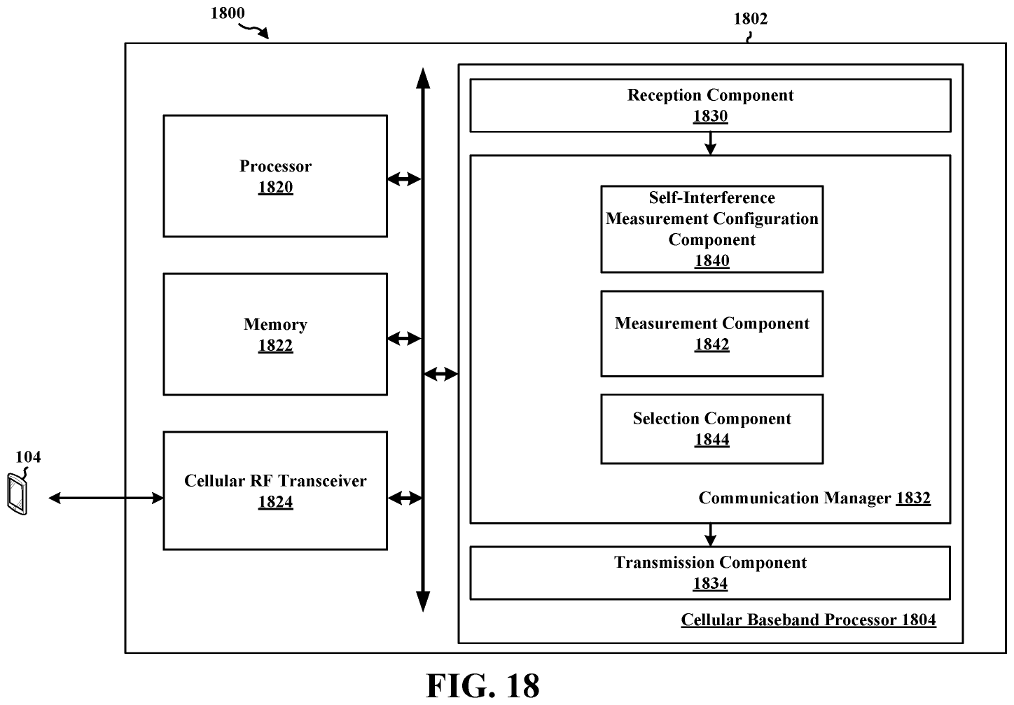

FIG. 18 is a diagram 1800 illustrating an example of a hardware implementation for an apparatus 1802. The apparatus 1802 may be a network entity, a base station or other wireless device that communicates based on downlink/uplink. Additionally, or alternatively, the apparatus 1802 may communicate using a sidelink, such as a PC5 interface. The apparatus 1802 may include a cellular baseband processor 1804 (also referred to as a modem) electrically coupled to a processor 1820, a memory 1822, and a cellular RF transceiver 1824 (e.g., via a bus system). The cellular baseband processor 1804 may communicate through the cellular RF transceiver 1824 with other wireless devices, such as a UE 104, 204, 450, 602, 702-1, 902, 1202, 1502 illustrated in FIGS. 1, 2, 4, 6A, 6C, 7B, 7C, 9, 12, 15. In some aspects, the UE 104 may be (or comprise) the apparatus 1702 illustrated in the diagram 1700 of FIG. 17.

The cellular baseband processor 1804 may be electrically coupled with a computer-readable medium/memory, which may be internal (e.g., memory within the cellular baseband processor 1804) and/or external, such as memory 1822. The cellular baseband processor 1804 may be responsible for general processing, including the execution of software stored on the computer-readable medium/memory. The software, when executed by the cellular baseband processor 1804, may cause the cellular baseband processor 1804 to perform the various functions described supra. The computer-readable medium/memory may also be used for storing data that is manipulated by the cellular baseband processor 1804 when executing software.

The processor 1820 may be responsible for general processing, including the execution of software stored on the computer-readable medium/memory 1822. The software, when executed by the processor 1820 and/or by the cellular baseband processor 1804, may cause the apparatus 1802 to perform the various functions described supra. The computer-readable medium/memory 1822 may also be used for storing data that is manipulated by the processor 1820 when executing software. The cellular baseband processor 1804 may further includes a reception component 1830, a communication manager 1832, and a transmission component 1834. The communication manager 1832 may include the one or more illustrated components. The components within the communication manager 1832 may be stored in computer-readable medium/memory and/or configured as hardware within the cellular baseband processor 1804, and they may be implemented in general as any suitable combination of software, firmware, and hardware.

For example, the cellular baseband processor 1804 may be a component of the base station 102/180 shown in FIG. 1, or the base station 410 shown in FIG. 4, and may include the memory 476 and/or at least one of the TX processor 416, the RX processor 470, and the controller/processor 475 (all illustrated in FIG. 4). In one configuration, the apparatus 1802 may be a modem chip and may include just the baseband processor 1804, and in another configuration, the apparatus 1802 may be the entire wireless device (e.g., see the base station 450 of FIG. 4) and include the additional modules of the apparatus 1802.

The communication manager 1832 may include a self-interference measurement (SIM) configuration component 1840, a measurement component 1842 and/or a selection component 1844 configured to perform one or more aspects relating to the network entity described, for example, in connection with the processes in FIGS. 12 and 14. The SIM configuration component 1840 may correspond to the self-interference measurement (SIM) configuration component 199 illustrated and described in connection with FIGS. 1, 2, 4. The apparatus 1802 is illustrated as including various components enabling the network entity to operate as a transmitting device at times and as a receiving device at other times.

The apparatus 1802 may include additional components that perform the aspects described in connection with the aforementioned flowcharts of FIGS. 12 and 14. As such, each block in the aforementioned flowcharts of FIGS. 12 and 14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

The apparatus 1802 may include means for configuring UE for self-interference measurement (SIM) process and means for receiving a SIM report from the UE. In some aspects, the apparatus 1802 may comprise means for outputting for transmission, to the UE, an indication of a configuration of one or more downlink (DL) symbols for performing a self-interference measurement (SIM), wherein the self-interference measurement (SIM) is based at least in part on the configuration of the one or more downlink (DL) symbols and a self-interference (SI) between at least one active uplink (UL) transmit (Tx) beam and at least one active downlink (DL) receive (Rx) beam.

The self-interference (SI) may be caused by radio frequency (RF) leakage between the UL Tx beam and the DL RX beam of the UE, in which case it is referred to as “leaked” self-interference. Additionally, or alternatively, the self-interference (SI) may be caused by reflections/echo from one or more nearby reflectors of the signal transmitted via the UL Tx beam by the UE, which is received indirectly as clutter echo at the DL Rx beam, in which case it is referred to as “clutter echoed” self-interference. In this disclosure, we may use only the general term “self-interference” to refer to either one or both types of “leaked” and “clutter echoed” self-interference.

The apparatus 1702 may comprise further means for obtaining a report of the self-interference measurement performed by the UE between the at least one active uplink (UL) transmit (Tx) beam of the UE and the at least one active downlink (DL) receive (Rx) beam of the UE, wherein the at least one active uplink (UL) transmit (Tx) beam is based at least in part on an uplink (UL) subcarrier spacing (SCS) and the at least one active downlink (DL) receive (Rx) beam is based at least in part on a downlink (DL) subcarrier spacing (SCS).

The aforementioned means may be one or more of the aforementioned components of the apparatus 1802 configured to perform the functions recited by the aforementioned means. As described supra, with reference to FIG. 4, the apparatus 1802 may include the TX processor 416, the RX processor 470, and the controller/processor 475. As such, in one configuration, the aforementioned means may be the TX processor 416, the RX processor 470, and the controller/processor 475 configured to perform the functions recited by the aforementioned means.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects or examples disclosed herein, but are to be accorded the full scope consistent with the present disclosure. In particular, reference to an element in the singular is not intended to mean “one and only one” unless specifically so stated, but rather “one or more”. The word “exemplary” is used herein to mean “serving as an example, instance, or illustration”. Any aspect described herein as “exemplary” is not necessarily to be construed as preferred or advantageous over other aspects. Unless specifically stated otherwise, the term “some” refers to one or more. The words “module”, “mechanism”, “element”, “device”, and the like may not be a substitute for the word “means”. As such, no claim element is to be construed as “means plus function”, unless the element is expressly recited using the phrase “means for”.

Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C”, “one or more of A, B, or C”, “at least one of A, B, and C”, “one or more of A, B, and C”, and “A, B, C, or any combination thereof” may be A only, B only, C only, A and B, A and C, B and C, or A and B and C, where any such combinations may contain one or more member or members of A, B, or C. As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C).

Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on”. It is understood that the specific order or hierarchy of blocks in the processes, flowcharts, and diagrams disclosed is an illustration of example approaches. Based upon design preferences, it is understood that the specific order or hierarchy of blocks in the processes, flowcharts, and diagrams may be rearranged. Further, some blocks may be combined or omitted. The accompanying method claims present elements of the various blocks in a sample order and are not meant to be limited to the specific order or hierarchy presented.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include selecting, choosing, establishing and the like.

In some aspects, a 5G access node may include an access node controller (ANC). The ANC may be a central unit (CU) of the distributed RAN. The backhaul interface to the next generation core network (NG-CN) may terminate at the ANC. The backhaul interface to neighboring next generation access nodes (NG-ANs) may terminate at the ANC. The ANC may include one or more TRPs (which may also be referred to as BSs, NR BSs, Node Bs, 5G NBs, APs, or some other term). As described above, a TRP may be used interchangeably with “cell”. The TRPs may be a DU (e.g., a gNB-DU). The TRPs may be connected to one ANC or more than one ANC. For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

At least in some aspects, the techniques described herein may be used for various wireless communications systems such as code division multiple access (CDMA), time division multiple access (TDMA), frequency division multiple access (FDMA), orthogonal frequency division multiple (OFDM) access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

In some aspects, the wireless communications systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. At least in some aspects, the techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The disclosure is not limited to the aspects and examples described herein, but it is to be accorded the broadest scope consistent with the principles and novel features disclosed herein. The following aspects are presented for illustration purposes only and in order to facilitate understanding and they may be combined with one or more aspects of other embodiments or teachings described herein, without limitation.

Aspect 1 is a method for wireless communications at a user equipment (UE) in a wireless communications system, comprising: determining one or more downlink (DL) symbols for measuring a self-interference (SI) between at least one active uplink (UL) transmit (Tx) beam of the UE and at least one active downlink (DL) receive (Rx) beam of the UE; wherein the at least one active uplink (UL) transmit (Tx) beam is based at least in part on an uplink (UL) subcarrier spacing (SCS), and the at least one active downlink (DL) receive (Rx) beam is based at least in part on a downlink (DL) subcarrier spacing (SCS); performing, based at least in part on the one or more downlink (DL) symbols, at least one self-interference measurement (SIM) between the at least one active uplink (UL) transmit (Tx) beam and the at least one active downlink (DL) receive (Rx) beam; and outputting for transmission, to a network entity, a report of the at least one self-interference measurement (SIM). The self-interference (SI) may be caused by radio frequency (RF) leakage between the UL Tx beam and the DL RX beam of the UE, in which case it is referred to as “leaked” self-interference. Additionally, or alternatively, the self-interference (SI) may be caused by reflections/echo from one or more nearby reflectors of the signal transmitted via the UL Tx beam by the UE, which is received indirectly as clutter echo at the DL Rx beam, in which case it is referred to as “clutter echoed” self-interference. In this disclosure, we may use only the general term “self-interference” to refer to either one or both types of “leaked” and “clutter echoed” self-interference.

Aspect 2 is the method of Aspect 1, further comprising: determining the at least one active uplink (UL) transmit (Tx) beam for transmitting at least one of uplink (UL) data or uplink (UL) control information to a first network node via a first antenna array panel of the UE; and determining the at least one active downlink (DL) receive (Rx) beam for receiving at least one of downlink (DL) data or downlink (DL) control information from a second network node via a second antenna array panel of the UE.

Aspect 3 is the method of Aspect 1 or Aspect 2, wherein: the at least one active uplink (UL) transmit (Tx) beam and the at least one active downlink (DL) receive (Rx) beam are associated with a full duplex (FD) communication mode of the UE.

Aspect 4 is the method of any of Aspects 1 to 3, wherein: the uplink (UL) subcarrier spacing (SCS) is different from the downlink (DL) subcarrier spacing (SCS).

Aspect 5 is the method of any of Aspects 2 to 4, wherein: the first network node and the second network node are associated with the network entity; and wherein: the first network node and the second network node are transmitter receiver points (TRPs), and the network entity is a giga Node B (gNB).

Aspect 6 is the method of any of Aspects 1 to 5, further comprising: obtaining, from the network entity, an indication of a selected pair of the at least one active uplink (UL) transmit (Tx) beam and the at least one active downlink (DL) receive (Rx) beam for a full duplex (FD) communication mode of the UE based at least in part on a value of the at least one self-interference measurement (SIM) satisfying a threshold.

Aspect 7 is the method of any of Aspects 2 to 6, wherein: the first network node and the second network node are different network nodes.

Aspect 8 is the method of any of Aspects 2 to 6, wherein: the first network node and the second network node are a same network node.

Aspect 9 is the method of any of Aspects 1 to 8, wherein: the one or more downlink (DL) symbols for measuring the self-interference (SI) are determined based at least in part on a configuration.

Aspect 10 is the method of Aspect 9, wherein the configuration comprises one of: an indication of a downlink (DL) receive (Rx) timing scheme; or an indication of an uplink (UL) transmit (Tx) timing scheme.

Aspect 11 is the method of Aspect 9 or Aspect 10, wherein the configuration comprises one of: an indication that the one or more downlink (DL) symbols of the at least one active downlink (DL) receive (Rx) beam at least partially overlap in time with one or more uplink (UL) symbols of the at least one active uplink (UL) transmit (Tx) beam; or an indication that the one or more downlink (DL) symbols of the at least one active downlink (DL) receive (Rx) beam fully overlap in time with one or more uplink (UL) symbols of the at least one active uplink (UL) transmit (Tx) beam.

Aspect 12 is the method of Aspect 11, wherein the configuration comprises: an indication of the one or more uplink (UL) symbols of the at least one active uplink (UL) transmit (Tx) beam.

Aspect 13 is the method of any of Aspects 9 to 12, further comprising: obtaining, from the network entity, an indication of the configuration.

Aspect 14 is the method of any of Aspects 9 to 12, wherein: the configuration is predefined.

Aspect 15 is the method of any of Aspects 9 to 12, wherein: the configuration is selected by the user equipment (UE).

Aspect 16 is the method of any of Aspects 1 to 15, further comprising: performing the at least one self-interference measurement (SIM) based on a per bandwidth part (BWP) and per component carrier (CC).

Aspect 17 is the method of any of Aspects 1 to 16, wherein: the downlink (DL) subcarrier spacing (SCS) is determined per downlink (DL) bandwidth part (BWP) per downlink (DL) component carrier (CC).

Aspect 18 is the method of any of Aspects 1 to 16, wherein: the downlink (DL) subcarrier spacing (SCS) is determined as a common downlink (DL) subcarrier spacing (SCS) for all configured downlink (DL) bandwidth parts (BWPs) per downlink (DL) component carrier (CC).

Aspect 19 is the method of Aspect 18, wherein the common downlink (DL) subcarrier spacing (SCS) is one of: a smallest subcarrier spacing (SCS) of all configured downlink (DL) bandwidth parts (BWPs) per downlink (DL) component carrier (CC); or a largest subcarrier spacing (SCS) of all configured downlink (DL) bandwidth parts (BWPs) per downlink (DL) component carrier (CC).

Aspect 20 is the method of any of Aspects 1 to 15, further comprising: performing the at least one self-interference measurement (SIM) based on a per component carrier (CC) irrespective of a bandwidth part (BWP).

Aspect 21 is the method of Aspect 20, wherein: the downlink (DL) subcarrier spacing (SCS) is determined per downlink (DL) component carrier (CC) as a downlink (DL) subcarrier spacing (SCS) of an active downlink (DL) bandwidth part (BWP) of the downlink (DL) component carrier (CC).

Aspect 22 is the method of any of Aspects 1 to 15, further comprising: performing the at least one self-interference measurement (SIM) based on a number (N) of resource blocks (RBs) of a downlink (DL) receive (Rx) bandwidth (BW) adjacent to an uplink (UL) transmit (Tx) bandwidth (BW).

Aspect 23 is the method of Aspect 22, wherein: the downlink (DL) subcarrier spacing (SCS) is determined as a common downlink (DL) subcarrier spacing (SCS) for all active downlink (DL) bandwidth parts (BWPs) of all downlink (DL) component carriers (CCs) in the downlink (DL) receive (Rx) bandwidth (BW).

Aspect 24 is the method of Aspect 23, wherein the common downlink (DL) subcarrier spacing (SCS) is one of: a smallest downlink (DL) subcarrier spacing (SCS) of all active downlink (DL) bandwidth parts (BWPs) of all downlink (DL) component carriers (CCs) in the downlink (DL) receive (Rx) bandwidth (BW); or a largest downlink (DL) subcarrier spacing (SCS) of all active downlink (DL) bandwidth parts (BWPs) of all downlink (DL) component carriers (CCs) in the downlink (DL) receive (Rx) bandwidth (BW).

Aspect 25 is the method of Aspect 22, wherein: the downlink (DL) subcarrier spacing (SCS) is determined as a common downlink (DL) subcarrier spacing (SCS) for all configured downlink (DL) bandwidth parts (BWPs) of all downlink (DL) component carriers (CCs) in the downlink (DL) receive (Rx) bandwidth (BW).

Aspect 26 is the method of Aspect 25, wherein the common downlink (DL) subcarrier spacing (SCS) is one of: a smallest downlink (DL) subcarrier spacing (SCS) of all configured downlink (DL) bandwidth parts (BWPs) of all component carriers (CCs) in the downlink (DL) receive (Rx) bandwidth (BW); or a largest downlink (DL) subcarrier spacing (SCS) of all configured downlink (DL) bandwidth parts (BWPs) of all component carriers (CCs) in the downlink (DL) receive (Rx) bandwidth (BW).

Aspect 27 is the method of any of Aspects 2 to 26, wherein determining the at least one active UL Tx beam comprises selecting the at least one active UL Tx beam.

Aspect 28 is the method of any of Aspects 2 to 26, wherein determining the at least one active DL Rx beam comprises selecting the at least one active DL Rx beam.

Aspect 29 is the method of any of Aspects 1 to 26, wherein determining the one or more DL symbols comprises selecting the one or more DL symbols.

Aspect 30 is the method of any of Aspects 2 to 26, wherein determining the at least one active UL Tx beam comprises receiving an indication of the at least one active UL Tx beam from the network entity.

Aspect 31 is the method of any of Aspects 2 to 26, wherein determining the at least one active DL Rx beam comprises receiving an indication of the at least one active DL Rx beam from the network entity.

Aspect 32 is the method of any of Aspects 1 to 26, wherein determining the one or more DL symbols comprises receiving an indication of the one or more DL symbols from the network entity.

Aspect 33 is an apparatus for wireless communications at a user equipment (UE) in a wireless communications system, comprising: a memory; and a processor coupled to the memory and configured to carry out the method of any of Aspects 1 to 32.

Aspect 34 is an apparatus for wireless communications at a user equipment (UE) in a wireless communications system, comprising means for carrying out the method of any of Aspects 1 to 32.

Aspect 35 is a computer program comprising instructions, which when the instructions are executed on a processor of an apparatus for wireless communications at a user equipment (UE) in a wireless communications system, cause said processor to carry out the method of any of Aspects 1 to 32.

Aspect 36 is a method for wireless communications at a network entity in a wireless communications system, comprising: obtaining a report of a self-interference measurement (SIM), performed by a UE, between at least one active uplink (UL) transmit (Tx) beam of the UE and at least one active downlink (DL) receive (Rx) beam of the UE; wherein the at least one active uplink (UL) transmit (Tx) beam is based at least in part on an uplink (UL) subcarrier spacing (SCS), and the at least one active downlink (DL) receive (Rx) beam is based at least in part on a downlink (DL) subcarrier spacing (SCS).

Aspect 37 is the method of Aspect 27, further comprising: outputting for transmission, to the UE, an indication of a configuration of one or more downlink (DL) symbols for performing the self-interference measurement (SIM); wherein the self-interference measurement (SIM) is based at least in part on the configuration of the one or more downlink (DL) symbols, a self-interference (SI) between the at least one active uplink (UL) transmit (Tx) beam and the at least one active downlink (DL) receive (Rx) beam.

Aspect 38 is the method of Aspects 36 or Aspect 37, further comprising: outputting for transmission, to the UE, an indication of the at least one active uplink (UL) transmit (Tx) beam of the UE.

Aspect 39 is the method of any of Aspects 36 to 38, further comprising: outputting for transmission, to the UE, an indication of the at least one active downlink (DL) receive (Rx) beam of the UE.

Aspect 40 is the method of any of Aspects 36 to 39, further comprising: outputting for transmission, to the UE, an indication of a beam configuration comprising at least one pair of an uplink (UL) transmit (Tx) beam and a corresponding downlink (DL) receive (Rx) beam to be utilized by the UE to perform full duplex communications with the network entity; wherein the beam configuration is based at least in part on the report of the self-interference measurement (SIM) received from the UE.

Aspect 41 is the method of any of Aspects 36 to 40, wherein the network entity is associated with at least a first network node and a second network node.

Aspect 42 is the method of Aspect 41, wherein the network entity is a giga Node B (gNB) and the first network node and the second network node are transmitter receiver points (TPRs). In one or more related aspects, the network entity may be a smallest component of a gNB, such as gNB Central Unit (gNB-CU) or a part thereof, configured or operable to perform the method of any of Aspects 36 to 41, and the first and second network nodes may be, respectively, a smallest component of a respective TRP configured or operable to perform the method of any of Aspects 36 to 41.

Aspect 43 is the method of Aspect 41, wherein the network entity is a giga Node B (gNB) and the first network node and the second network node are gNB Distributed Units (gNB-DUs). In one or more related aspects, the network entity may be a smallest component of a gNB, such as gNB Central Unit (gNB-CU) or a part thereof, configured or operable to perform the method of any of Aspects 36 to 41, and the first and second network nodes may be, respectively, a smallest component of a respective gNB-DU configured or operable to perform the method of any of Aspects 36 to 41.

Aspect 44 is the method of one or more of Aspects 36 to 43, further comprising: determining the at least one active uplink (UL) transmit (Tx) beam of the UE for the UE to transmit at least one of uplink (UL) data or uplink (UL) control information to a first network node via a first antenna array panel of the UE; and determining the at least one active downlink (DL) receive (Rx) beam of the UE for the UE to receive at least one of downlink (DL) data or downlink (DL) control information from a second network node via a second antenna array panel of the UE.

Aspect 45 is the method of one or more of Aspects 36 to 44, wherein: the at least one active uplink (UL) transmit (Tx) beam of the UE and the at least one active downlink (DL) receive (Rx) beam of the UE are associated with a full duplex (FD) communication mode of the user equipment (UE).

Aspect 46 is the method of one or more of Aspects 36 to 45, wherein: the uplink (UL) subcarrier spacing (SCS) is different from the downlink (DL) subcarrier spacing (SCS).

Aspect 47 is the method of one or more of Aspects 36 to 46, further comprising: outputting for transmission, to the UE, an indication of a selected pair of the at least one active uplink (UL) transmit (Tx) beam and the at least one active downlink (DL) receive (Rx) beam for a full duplex (FD) communication mode of the UE based at least in part on a value of the at least one self-interference measurement (SIM) satisfying a threshold (condition). In some aspects, satisfying the threshold (condition) means that the at least one SIM value should be less than (or at most equal to) the threshold, wherein the threshold may be predefined or configurable. In related aspects, the indication of the selected pair may indicate that there is no pair of active UL Tx/DL Rx beams of the UE satisfying the threshold (condition).

Aspect 48 is the method of one or more of Aspects 36 to 47, wherein: the first network node and the second network node are different network nodes.

Aspect 49 is the method of one or more of Aspects 36 to 47, wherein: the first network node and the second network node are a same network node.

Aspect 50 is the method of one or more of Aspects 36 to 49, wherein the configuration of the one or more downlink (DL) symbols for performing the self-interference measurement (SIM) by the UE comprises: an indication of a downlink (DL) receive (Rx) timing scheme, or an indication of an uplink (UL) transmit (Tx) timing scheme, or both.

Aspect 51 is the method of one or more of Aspects 36 to 50, wherein the configuration of the one or more downlink (DL) symbols for performing the self-interference measurement (SIM) by the UE comprises one of: an indication that the one or more downlink (DL) symbols of the at least one active downlink (DL) receive (Rx) beam at least partially overlap in time with one or more uplink (UL) symbols of the at least one active uplink (UL) transmit (Tx) beam; or an indication that the one or more downlink (DL) symbols of the at least one active downlink (DL) receive (Rx) beam fully overlap in time with one or more uplink (UL) symbols of the at least one active uplink (UL) transmit (Tx) beam.

Aspect 52 is the method of one or more of Aspects 36 to 51, wherein the configuration of the one or more downlink (DL) symbols for performing the self-interference measurement (SIM) by the UE comprises: an indication of the one or more uplink (UL) symbols of the at least one active uplink (UL) transmit (Tx) beam.

Aspect 53 is the method of one or more of Aspects 36 to 52, further comprising: outputting for transmission, to the UE, an indication of a configuration for performing the at least one self-interference measurement (SIM) based on a per bandwidth part (BWP) and per component carrier (CC).

Aspect 54 is the method of one or more of Aspects 36 to 53, wherein: the downlink (DL) subcarrier spacing (SCS) is determined per downlink (DL) bandwidth part (BWP) per downlink (DL) component carrier (CC).

Aspect 55 is the method of one or more of Aspects 36 to 53, wherein: the downlink (DL) subcarrier spacing (SCS) is determined as a common downlink (DL) subcarrier spacing (SCS) for all configured downlink (DL) bandwidth parts (BWPs) per downlink (DL) component carrier (CC).

Aspect 56 is the method of Aspect 55, wherein the common downlink (DL) subcarrier spacing (SCS) is one of: a smallest subcarrier spacing (SCS) of all configured downlink (DL) bandwidth parts (BWPs) per downlink (DL) component carrier (CC); or a largest subcarrier spacing (SCS) of all configured downlink (DL) bandwidth parts (BWPs) per downlink (DL) component carrier (CC).

Aspect 57 is the method of one or more of Aspects 36 to 52, further comprising: outputting for transmission, to the UE, an indication of a configuration for performing the at least one self-interference measurement (SIM) based on a per component carrier (CC) irrespective of a bandwidth part (BWP).

Aspect 58 is the method of Aspect 57, wherein: the downlink (DL) subcarrier spacing (SCS) is determined per downlink (DL) component carrier (CC) as a downlink (DL) subcarrier spacing (SCS) of an active downlink (DL) bandwidth part (BWP) of the downlink (DL) component carrier (CC).

Aspect 59 is the method of one or more of Aspects 36 to 52, further comprising: outputting for transmission, to the UE, an indication of a configuration for performing the at least one self-interference measurement (SIM) based on a number (N) of resource blocks (RBs) of a downlink (DL) receive (Rx) bandwidth (BW) adjacent to an uplink (UL) transmit (Tx) bandwidth (BW).

Aspect 60 is the method of Aspect 59, wherein: the downlink (DL) subcarrier spacing (SCS) is determined as a common downlink (DL) subcarrier spacing (SCS) for all active downlink (DL) bandwidth parts (BWPs) of all downlink (DL) component carriers (CCs) in the downlink (DL) receive (Rx) bandwidth (BW).

Aspect 61 is the method of Aspect 60, wherein the common downlink (DL) subcarrier spacing (SCS) is one of: a smallest downlink (DL) subcarrier spacing (SCS) of all active downlink (DL) bandwidth parts (BWPs) of all downlink (DL) component carriers (CCs) in the downlink (DL) receive (Rx) bandwidth (BW); or a largest downlink (DL) subcarrier spacing (SCS) of all active downlink (DL) bandwidth parts (BWPs) of all downlink (DL) component carriers (CCs) in the downlink (DL) receive (Rx) bandwidth (BW).

Aspect 62 is the method of Aspect 59, wherein: the downlink (DL) subcarrier spacing (SCS) is determined as a common downlink (DL) subcarrier spacing (SCS) for all configured downlink (DL) bandwidth parts (BWPs) of all downlink (DL) component carriers (CCs) in the downlink (DL) receive (Rx) bandwidth (BW).

Aspect 63 is the method of Aspect 62, wherein the common downlink (DL) subcarrier spacing (SCS) is one of: a smallest downlink (DL) subcarrier spacing (SCS) of all configured downlink (DL) bandwidth parts (BWPs) of all component carriers (CCs) in the downlink (DL) receive (Rx) bandwidth (BW); or a largest downlink (DL) subcarrier spacing (SCS) of all configured downlink (DL) bandwidth parts (BWPs) of all component carriers (CCs) in the downlink (DL) receive (Rx) bandwidth (BW).

Aspect 64 is an apparatus for wireless communications at a network entity in a wireless communications system, comprising: a memory; and a processor coupled to the memory and configured to implement any of Aspects 36 to 63.

Aspect 65 is an apparatus for wireless communications at a network entity in a wireless communications system, comprising means for implementing any of Aspects 36 to 63.

Aspect 66 is a computer program comprising instructions, which when the instructions are executed on a processor of an apparatus for wireless communications at a network entity in a wireless communications system, cause said processor implement any of Aspects 36 to 63.

1. An apparatus for wireless communications at a user equipment (UE) in a wireless communications system, comprising:
a memory; and
a processor coupled to the memory and configured to:
determine one or more downlink symbols for measuring a self-interference between at least one active uplink transmit beam of the UE and at least one active downlink receive beam of the UE, wherein the at least one active uplink transmit beam is based at least in part on an uplink subcarrier spacing, and the at least one active downlink receive beam is based at least in part on a downlink subcarrier spacing;
perform, based at least in part on the one or more downlink symbols, at least one self-interference measurement between the at least one active uplink transmit beam and the at least one active downlink receive beam; and
output for transmission, to a network entity, a report of the at least one self-interference measurement.

2. The apparatus of claim 1, wherein the processor is further configured to:
determine the at least one active uplink transmit beam for transmitting at least one of uplink data or uplink control information to a first network node via a first antenna array panel of the UE; and
determine the at least one active downlink receive beam for receiving at least one of downlink data or downlink control information from a second network node via a second antenna array panel of the UE.

3. The apparatus of claim 1, wherein:
the at least one active uplink transmit beam and the at least one active downlink receive beam are associated with a full duplex communication mode of the UE.

4. The apparatus of claim 1, wherein:
the uplink subcarrier spacing is different from the downlink subcarrier spacing.

5. The apparatus of claim 2, wherein:
the first network node and the second network node are associated with the network entity; and wherein:
the first network node and the second network node are transmitter receiver points (TRPs), and the network entity is a giga Node B (gNB).

6. The apparatus of claim 1, wherein the processor is further configured to:
obtain, from the network entity, an indication of a selected pair of the at least one active uplink transmit beam and the at least one active downlink receive beam for a full duplex communication mode of the UE based at least in part on a value of the at least one self-interference measurement satisfying a threshold.

7. The apparatus of claim 2, wherein:
the first network node and the second network node are different network nodes.

8. The apparatus of claim 2, wherein:
the first network node and the second network node are a same network node.

9. The apparatus of claim 1, wherein:
the one or more downlink symbols for measuring the self-interference are determined based at least in part on a configuration.

10. The apparatus of claim 9, wherein the configuration comprises one of:
an indication of a downlink receive timing scheme; or
an indication of an uplink transmit timing scheme.

11. The apparatus of claim 9, wherein the configuration comprises one of:
an indication that the one or more downlink symbols of the at least one active downlink receive beam at least partially overlap in time with one or more uplink symbols of the at least one active uplink transmit beam; or
an indication that the one or more downlink symbols of the at least one active downlink receive (Rx) beam fully overlap in time with one or more uplink symbols of the at least one active uplink transmit (Tx) beam.

12. The apparatus of claim 11, wherein the configuration comprises:
an indication of the one or more uplink symbols of the at least one active uplink transmit beam.

13. The apparatus of claim 9, wherein the processor is further configured to:
obtain, from the network entity, an indication of the configuration.

14. The apparatus of claim 9, wherein:
the configuration is predefined.

15. The apparatus of claim 9, wherein:
the configuration is selected by the user equipment (UE).

16. The apparatus of claim 1, wherein the processor is further configured to:
perform the at least one self-interference measurement based on a per bandwidth part and per component carrier.

17. The apparatus of claim 1, wherein:
the downlink subcarrier spacing is determined per downlink bandwidth part per downlink component carrier.

18. The apparatus of claim 1, wherein:
the downlink subcarrier spacing is determined as a common downlink subcarrier spacing for all configured downlink bandwidth parts per downlink component carrier.

19. The apparatus of claim 18, wherein the common downlink subcarrier spacing is one of:
a smallest subcarrier spacing of all configured downlink bandwidth parts per downlink component carrier; or
a largest subcarrier spacing of all configured downlink bandwidth parts per downlink component carrier.

20. The apparatus of claim 1, wherein the processor is further configured to:
perform the at least one self-interference measurement based on a per component carrier irrespective of a bandwidth part.

21. The apparatus of claim 20, wherein:
the downlink subcarrier spacing is determined per downlink component carrier as a downlink subcarrier spacing of an active downlink bandwidth part of the downlink component carrier.

22. The apparatus of claim 1, wherein the processor is further configured to:
perform the at least one self-interference measurement based on a number of resource blocks of a downlink receive bandwidth adjacent to an uplink transmit bandwidth.

23. The apparatus of claim 22, wherein:
the downlink subcarrier spacing is determined as a common downlink subcarrier spacing for all active downlink bandwidth parts of all downlink component carriers in the downlink receive (Rx) bandwidth (BW).

24. The apparatus of claim 23, wherein the common downlink subcarrier spacing is one of:
a smallest downlink subcarrier spacing of all active downlink bandwidth parts of all downlink component carriers in the downlink receive bandwidth; or
a largest downlink subcarrier spacing of all active downlink bandwidth parts of all downlink component carriers in the downlink receive bandwidth.

25. The apparatus of claim 22, wherein:
the downlink subcarrier spacing is determined as a common downlink subcarrier spacing for all configured downlink bandwidth parts of all downlink component carriers in the downlink receive bandwidth.

26. The apparatus of claim 25, wherein the common downlink subcarrier spacing is one of:
a smallest downlink subcarrier spacing of all configured downlink bandwidth parts of all component carriers in the downlink receive bandwidth; or
a largest downlink subcarrier spacing of all configured downlink bandwidth parts of all component carriers in the downlink receive bandwidth.

27. An apparatus for wireless communications at a network entity in a wireless communications system, comprising:
a memory; and
a processor coupled to the memory and configured to:
obtain a report of a self-interference measurement, performed by a user equipment (UE), between at least one active uplink transmit beam of the UE and at least one active downlink receive beam of the UE,
wherein the at least one active uplink transmit beam is based at least in part on an uplink subcarrier spacing, and the at least one active downlink receive beam is based at least in part on a downlink subcarrier spacing.

28. The apparatus of claim 27, wherein the processor is further configured to:
output for transmission, to the UE, an indication of a configuration of one or more downlink symbols for performing the self-interference measurement, wherein the self-interference measurement is based at least in part on the configuration of the one or more downlink symbols, a leaked or clutter echoed self-interference between the at least one active uplink transmit beam and the at least one active downlink receive beam.

29. A method for wireless communications at an apparatus for wireless communications at a user equipment (UE) in a wireless communications system, comprising:
determining one or more downlink symbols for measuring a self-interference between at least one active uplink transmit beam of the UE and at least one active downlink receive beam of the UE, wherein the at least one active uplink transmit beam is based at least in part on an uplink subcarrier spacing, and the at least one active downlink receive beam is based at least in part on a downlink subcarrier spacing;
performing, based at least in part on the one or more downlink symbols, at least one self-interference measurement between the at least one active uplink transmit beam and the at least one active downlink receive beam; and
outputting for transmission, to a network entity, a report of the at least one self-interference measurement.

30. A computer program comprising instructions, which when the instructions are executed on a processor of an apparatus for wireless communications at a user equipment (UE) in a wireless communications system, cause the processor to:
determine one or more downlink symbols for measuring a self-interference between at least one active uplink transmit beam of the UE and at least one active downlink receive beam of the UE, wherein the at least one active transmit beam is based at least in part on an uplink subcarrier spacing, and the at least one active downlink receive beam is based at least in part on a downlink subcarrier spacing;
perform, based at least in part on the one or more downlink symbols, at least one self-interference measurement between the at least one active uplink transmit beam and the at least one active downlink receive beam; and
output for transmission, to a network entity, a report of the at least one self-interference measurement.
